(19) United States
(12) Patent Application Publication
(10) Pub. No.: US 2026/0220210 A1
(43) Pub. Date: Jul. 30, 2026

(54) CONNECTED DATA ARCHITECTURE

(71) Applicant: Docusign, Inc., San Francisco, CA (US)

(72) Inventors: Abhinav Jain, Redmond, WA (US); Kunal Mukerjee, Seattle, WA (US); Nikhil Patel, Kirkland, WA (US)

(73) Assignee: Docusign, Inc., San Francisco, CA (US)

(21) Appl. No.: 19/040,563

(22) Filed: Jan. 29, 2025

(51) Int. Cl. G06F 16/93

(52) U.S. Cl. CPC G06F 16/93

(57) ABSTRACT

A method, a system, and a computer program product for connecting computing systems. A connection request to connect with one or more computing systems is received. Based on the connection request, at least one computing system in one or more computing systems is identified. The computing system is identified based on one or more tasks associated with the connection request and to be performed using the computing system. A connection interface for connection with the computing system is dynamically generated. The connection interface is generated using a connection data model associated with the computing system. Connection, using the connection interface to the computing system, is formed, and one or more tasks is executed using the connection interface.

### BACKGROUND

Proper connections between different computing systems are important to ensure seamless communications, data exchanges, and overall operational efficiency of such systems. When computing systems are well-connected, they are able to share resources, data, information, etc. effectively and accurately, which leads to improved performance and productivity. System connectivity is important for data synchronization, real-time processing, collaborative work environments, etc. Additionally, robust connections can help maintain system security by enabling updates, monitoring across connected devices, etc. However, existing computing systems lack an ability to provide connection interfaces that ensure proper connections are made, thereby allowing for a seamless connection experience for task execution purposes.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example connection management system for providing connectivity among various computing systems, such as, for example, for the purposes of performing various tasks (e.g., electronic document creation, electronic document management, electronic document execution or signing, execution of applications, etc.), according to some embodiments of the current subject matter.

FIG. 2 illustrates an example connection system, according to some embodiments of the current subject matter.

FIG. 3 illustrates an example connection system, according to some embodiments of the current subject matter.

FIG. 4 illustrates an example connection data model, according to some embodiments of the current subject matter.

FIG. 5 illustrates an embodiment of a system where connected data engine may be implemented.

FIG. 6 illustrates an example of document storage location(s) that may be used as a source for the electronic documents, according to some embodiments of the current subject matter.

FIG. 7 illustrates a document corpus in accordance with one embodiment.

FIG. 8 illustrates electronic documents in accordance with one embodiment.

FIG. 9 illustrates an example process for connecting computing systems, according to some embodiments of the current subject matter.

FIG. 10 illustrates another example process for connecting computing systems, according to some embodiments of the current subject matter.

FIG. 11 illustrates yet another example process for connecting computing systems, according to some embodiments of the current subject matter.

FIG. 12 illustrates a computer-readable storage medium, according to some embodiments of the current subject matter.

FIG. 13 illustrates a computing architecture, according to some embodiments of the current subject matter.

FIG. 14 illustrates a communications architecture, according to some embodiments of the current subject matter.

### DETAILED DESCRIPTION

Embodiments disclosed herein are generally directed to providing various interfaces among computing systems to enable generation and management of electronic documents and/or performing of any other tasks involving data associated with third-party computing systems. In general, a document may include a multimedia record. The term “electronic” may refer to technology having electrical, digital, magnetic, wireless, optical, electromagnetic, or similar capabilities. The term “electronic document” may refer to any electronic multimedia content intended to be used in an electronic form. An electronic document may be part of an electronic record. The term “electronic record” may refer to a contract or other record created, generated, sent, communicated, received, or stored by an electronic mechanism. An electronic document may have an electronic signature. The term “electronic signature” may refer to an electronic sound, symbol, or process, attached to or logically associated with an electronic document, such as a contract or other record, and executed or adopted by a person with the intent to sign the record.

An online electronic document management system provides a host of different benefits to users (e.g., a client or customer) of the system. One advantage is added convenience in generating and signing an electronic document, such as a legally binding agreement. Parties to an agreement can review, revise and sign the agreement from anywhere around the world on a multitude of electronic devices, such as computers, tablets and smartphones.

In some embodiments, the current subject matter relates to providing connectivity among various computing systems to allow use and/or integration of computing capabilities and/or data of one or more computing systems into one or more other computing systems. The connectivity may be created based on various data models, parameters, etc. that may be retrieved, obtained and/or generated. Such data models, parameters, etc. may be specific to the computing system that another computing system (e.g., a user of such computing system) may wish to use and/or integrate with and/or into. For example, ABC Company is in a process of negotiating a sales agreement with XYZ Company. User(s) of a computing system of the ABC Company and would like to obtain various contractual data, requirements, etc. associated with the XYZ Company for inclusion into the sales agreement. To do so, the computing systems of the ABC Company and XYZ Company may need to exchange certain parameters about each other's system to enable queries, requests, etc. from one computing system to be understood by another computing system. One or more interfaces may need to be established to provide connectivity between the computing systems, provide an ability to access data, applications, executables, etc. of one computing system by another and vice versa (assuming appropriate permissions are granted), handle, including translation, processing, formatting, etc. of queries, requests, etc. by the computing systems, as well as perform any other operations. In another example, non-limiting, implementation, the current subject matter's connectivity among computing systems, using a connection interface, as discussed herein, may, for instance, greatly simplify electronic document (e.g., agreement) workflows. Such electronic document workflows may involve retrieval of data that may be stored by one external computing system (e.g., XYZ Company's computing system), performing various actions on the data by originating computing system (e.g., ABC Company's computing system), and writing data (e.g., final terms of an agreement) back to the external computing system and/or to another computing system. As can be understood, the current subject matter's connectivity may be used in any other workflows, tasks, operations, etc.

In the above example, the current subject matter may be configured to generate, in real-time and/or dynamically, a connection interface between computing system of ABC Company and computing system of XYZ Company to provide such connectivity between the computing systems, provide access to data, applications, executables, etc. of and/or by one computing system (e.g., ABC Company's) by another computing system (e.g., XYZ company's) and vice versa (again with appropriate permissions being granted), handle, including translation, processing, formatting, etc. of queries, requests, etc. by the computing systems, implement various functionalities of the XYZ Company's computing system, etc. (again assuming appropriate permissions to do so are granted a priori) as if that user was using XYZ Company's computing system while being in the ABC Company computing system environment, and/or implement any other functionalities, operations, etc. The connection interface may be a newly formed connection interface, an existing connection interface, a dynamically generated interface within the ABC Company's computing system's computing environment, and/or any other type of connection interface. Dynamic generation of connection data models may also involve instantiation (e.g., dynamically provisioning) and/or refreshing (e.g., including refreshing on-demand) of connection data models (whether existing and/or newly formed). This may allow seamless integration of capabilities, functionalities, data, etc. of XYZ Company's computing system into ABC Company's computing system without the user of the ABC Company's computing system needing to separately access XYZ Company's computing system (e.g., download and install separate application, receive access, etc.). As can be understood, such connection interface may provide any of the above (as associated with the ABC Company's computing system) to XYZ Company's computing system. The connection interface may allow bridging the ABC Company's computing system and the XYZ Company's computing system (e.g., via one or more interfaces of the XYZ Company's computing system).

The connection interface (e.g., an application programming interface) may be generated based on various connection data models that may define various aspects of the connection interface, which may include, but not limited to, which data may be accessed, how tasks, queries, requests, etc. from one computing system to another computing system and vice versa may need to translated, formatted, executed, etc., which applications, computing modules, functionalities, plug-ins, etc. of one computing system may be accessed and/or executed by another computing system and vice versa. The data model may allow one computing system, using the generated connection interface, to operate within the computing environment of another computing system (and/or operate as if it was operating within the computing environment of another computing system) without having to install any of the specific software, download data, etc. of such other computing system, while being able to provide queries, requests, etc. to the other computing system in a form, format, etc. that is native to such computing system.

In some embodiments, the connection data model(s), which are used to generate connection interfaces, may be generated based on various connection parameters associated with one or both computing systems. For example, one connection parameter may define how data is written to one or both computing systems (e.g., in what format the data is written, etc.), another connection parameter may define how data is read from one or both computing systems, yet another connection parameter may define how queries, requests, etc. are translated into (and/or back and forth) the specific language, format, etc. of the computing system from which data is being sought, a further connection parameter may define specific interfaces that may need to be executed to provide connectivity for specific functions (e.g., reading data, writing data, managing data, executing one or more features, applications, etc. of computing systems, etc.), etc. As can be understood, any type of connection parameters may be used for the purposes of generating connection data model(s). The connection parameters may be provided by the computing system, e.g., XYZ Company's computing system, which another computing system, e. g., ABC Company's computing system, wishes to access. Alternatively, or in addition, the connection data model(s) may also be generated using one or more connection parameters associated with the ABC Company's computing system. This may ensure that any data, applications, executables, etc., which may be received from the XYZ Company's computing system may be used by the ABC Company's computing system. Such ABC Company's computing system connection parameters may define similar functionalities to those discussed above.

In some embodiments, while connection data model(s) may be generated dynamically (e.g., in response to receiving a request to access data of a computing system) and/or in real-time, one or more existing connection data model(s) may be retrieved from a storage location. Such existing connection data model(s) may have been generated based on historical or prior connections between computing systems, where such historical/prior connections may have been associated with the same and/or different requests and/or purposes. Moreover, the historical/prior connections may have been formed as a result of connections initiated by any computing system for which existing connection data model(s) may have been generated. Further, the connection data model(s) may be generated using information, data, etc. related to prior request(s), task(s), sub-task(s), etc. that have been stored. This may allow reusing stored information, data, etc. for the purposes of generating connection data model(s), which may enable dynamic generation of connection interface(s) based on stored information, data, etc. Moreover, in some example embodiments, existing connection data models may be retrieved from a storage location by comparing various parameters associated with the received request(s), task(s), sub-task(s), etc. with parameters associated with the stored connection data model(s). If a match is found (full and/or partial), specific connection data model(s) may be retrieved for the purposes of generating connection interface(s). If no match is found, one or more new connection data model(s) may be generated. The new connection data model(s) may be generated using new parameters in the request(s), task(s), sub-task(s), etc. and/or based on various combinations of parameters associated with the request(s), task(s), sub-task(s), etc. and/or parameters associated with stored connection data model(s). In some embodiments, the stored information, data, etc. (including any stored search queries and/or results, stored connection data models, etc.) may be retrieved and/or may be used to retrieve information, data, etc. in real-time across multiple computing systems that may be currently and/or previously connected using one or more connection data models. This may allow expedited retrieval information via such connection data model(s) and/or interfaces of computing systems. Embodiments are not limited in that regard.

Once connection data model(s) are either generated and/or retrieved from a storage location, one or more connection interfaces may be generated based on such models. Any requests from one computing system to another computing system routed through the generated connection interface(s) may be appropriately translated, formatted, etc. to ensure “understanding” by the computing system receiving the request, where, for instance, the request may be interpreted by the receiving computing system as if it were generated within same computing system. The requests may include data queries, use of certain functionalities, and/or any other operations. Response(s) to requests, as generated by the request-receiving computing system, may be translated back to the request-generating computing system to ensure “understanding” of the response(s).

For instance, ABC Company's computing system (e.g., request-generating computing system) may generate a request seeking access to sales data stored in a first format by XYZ Company's computing system (e.g., request-receiving computing system). Upon receiving the request, the current subject matter may be configured to generate and/or retrieve from a storage location connection data model(s) to generate a connection interface between computing systems of both companies. The request, using the connection interface, may be translated into the first format to ensure that the XYZ Company's computing system is able to interpret and understand it without further translation into its computing environment. The XYZ Company's computing system may process the translated request and generate a response, e.g., sales data. The sales data may be in the native format of the XYZ Company's computing system, which the ABC Company's computing system might not be able to understand, and thus, use. Once the response is received by the connection interface, it may be translated into the native format of the ABC Company's computing system to ensure its understanding and, hence, use. As can be understood, such translations may involve any type of modifications, changes, etc. to various aspects associated with request(s), response(s), etc. For instance, in case of applications, executables, etc., the current subject matter's connection interface may be configured to generate plug-in(s), code, etc., which may ensure interoperability of such within appropriate computing systems. In an example of electronic documents, various formatting operations may be performed to ensure readability of such documents, etc. As can be understood, any other types of translations may be performed by the connection interface. The connection interface may use the connection data model(s) to perform such translations. In some example, non-limiting, embodiments, the connection interface may be configured to perform processing of various data, formats, fields, etc. from an external computing system (e.g., XYZ Company's computing system) that may be unsupported, unrecognized, and/or do not exist in the originating computing system (e.g., ABC Company's computing system). Such data, formats, fields, etc. may be partially processed by the connection interface. For example, a set of unrecognized fields, e.g., a governing law clause for a foreign jurisdiction, may be partially mapped to the electronic lease agreement using the connection interface by mapping a partial text of the governing law clause without mapping aspects associated with the foreign jurisdiction to the electronic lease agreement. Alternatively, or in addition, such data, formats, fields, etc. may be ignored and/or mapped in any other way (e.g., as static objects, images, etc.). Embodiments are not limited in that regard.

The current subject matter may have one or more of the following technical benefits. In one example, the current subject matter may be configured to dynamically and/or in real-time generate various connection interfaces (e.g., application programming interfaces, etc.) that may allow seamless connections among different computing systems to enable handling of various requests and responses thereto without the need of using specific computing components to perform interpretation or translation of requests/responses for each different computing system. Generation of such connections ensures interoperability of computing systems as they generated based on connection data model(s) relying on connection parameters that are specific to the computing system with which connection is sought. Dynamic and/or real-time generation of connection interfaces ensure immediate processing of requests/responses, which, in turn, enhances user experience of computing systems. Moreover, the current subject matter may be configured to remove the necessity and/or requirements of one computing system being tightly coupled and/or connection with another computing system, while still being able to leverage various capabilities of such system (e.g., read, write, search, update, compute data, etc.) in a consistent manner. Additionally, the current subject matter may enable usage of connected data models during training and/or deploying artificial intelligence and/or machine learning models to provide end users with enhanced user experience when determining which data to include in electronic documents (e.g., agreement documents, etc.) irrespective of the source of such data. The current subject matter may provide end users with an ability to filter data sources based on, for example, but not limited to, semantic meaning of the data label, model capabilities (e.g., read, write, verify, evaluate, execute etc.), and/or any other factors.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application, or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct, or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

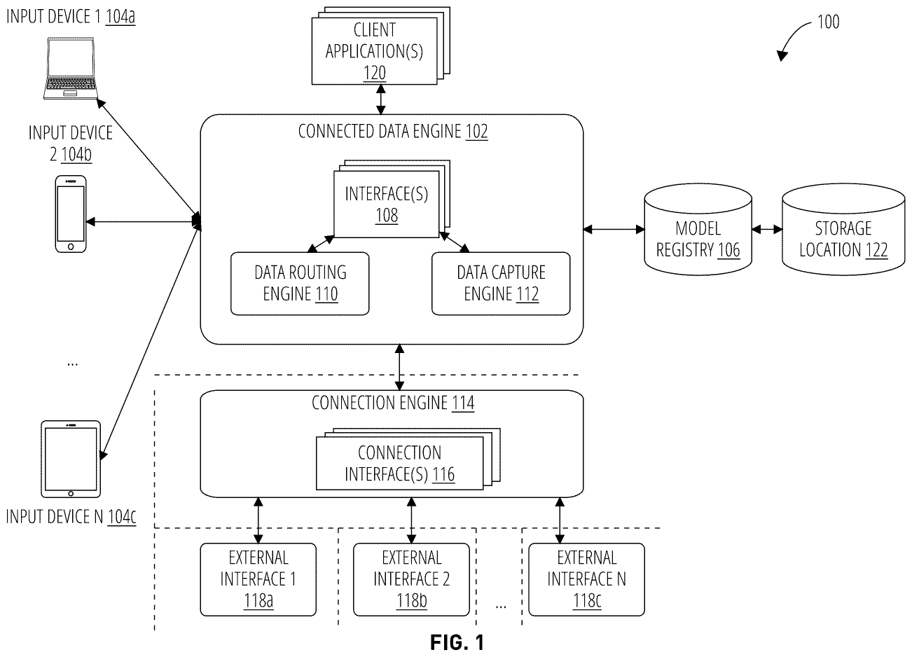

FIG. 1 illustrates an example connection management system 100 for providing connectivity among various computing system, such as, for example, for the purposes of performing various tasks (e.g., electronic document creation, electronic document management, electronic document execution or signing, execution of applications, etc.), according to some embodiments of the current subject matter. The system 100 may include a connected data engine 102, one or more input devices 104, a model registry 106, and one or more client application(s) 120. The system 100 may include various other computing components that may be configured to support operation of the connected data engine 102 in generating connectivity of various different computing systems.

In some embodiments, the connected data engine 102 may be communicatively coupled to connection engine 114 that may be configured to provide one or more connection interface(s) 116 between the connected data engine 102 and one or more external interfaces 118 (a, b, . . . c). The external interfaces 118 may be interfaces of various computing systems that may be external to the computing system that includes connected data engine 102. For example, external interface 1 118a may be part of one computing system, while external interface 2 118b may be part of another computing system, etc. As can be understood, one computing system may have one or more external computing interfaces 118. Each computing interface 118 may be associated with a specific software application (e.g., document generation, data access and retrieval, system security, etc.), computing environment, etc. and/or the entire computing system. The connection interface(s) 116 may be newly formed connection interface(s), existing connection interface(s), dynamically/real-time generated connection interface(s), and/or any other type of connection interface(s), which may be generated within the computing system 100. The external interface(s) 118 may be native to the computing system with which connection is desired.

In some embodiments, the connected data engine 102 may also implement one or more machine learning (ML) models, which may be used by the engine 102 during and/or for the purposes of generation of connection interfaces, connection data models, etc. The ML models may be trained based on historical data associated with historical connections with external computing systems. Such historical data may include connection interfaces, connection parameters, connection data models, connection error data, etc.

One or more components of the system 100 shown in FIG. 1 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, one or more components of the system 100 may include any combination of hardware and/or software. In some embodiments, one or more components of the system may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example embodiments, one or more components of the system may be disposed on a single computing device and/or may be part of a single communications network. Alternatively, or in addition to, such devices may be separately located from one another. A device may be a computing processor, a memory, a software functionality, a routine, a procedure, a call, and/or any combination thereof that may be configured to execute a particular function associated with interface and/or document certification processes disclosed herein.

In some embodiments, one or more components of the system 100 may include network enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the interface and/or document certification functions described herein. One or more components of the system may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some example embodiments, one or more components of the system 100 may execute one or more applications, such as software applications, that enable, for example, network communications with one or more components of system and transmit and/or receive data.

One or more components of the system 100 may include and/or be in communication with one or more servers via one or more networks and may operate as a respective front-end to back-end pair with one or more servers. One or more components of the system may transmit, for example from a mobile device application (e.g., executing on one or more user devices, components, etc.), one or more requests to one or more servers. The requests may be associated with retrieving data from servers (e.g., retrieving one or more electronic documents from one or more document storage sources, retrieval of connection parameters, connection data models, etc.). The servers may receive the requests from the components of the system. Based on the requests, servers may be configured to retrieve the requested data from one or more storage locations. Based on receipt of the requested data from the databases, the servers may be configured to transmit the received data to one or more components of the system, where the received data may be responsive to one or more requests.

The system 100 may include one or more networks, such as, for example, networks that may be communicatively coupling the engine 102, the connection engine 114, input devices 104, client application(s) 120, and/or any other computing components. In some embodiments, networks may be one or more of a wireless network, a wired network or any combination of wireless network and wired network and may be configured to connect the components of the system and/or the components of the system to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that may be coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system.

Further, one or more components of the system 100 may be configured to execute one or more actions using one or more containers. In some embodiments, each action may be executed using its own container. A container may refer to a standard unit of software that may be configured to include the code that may be needed to execute the action along with all its dependencies. This may allow execution of actions to run quickly and reliably.

In some embodiments, the system 100 may be configured to provide connection interfaces between various computing system for the purposes of generating, managing, etc. of various electronic documents that may be stored in various data storages. For example, some data storages may be configured to be one or more private databases, access to which might not be publicly available (e.g., internal company databases, specific user access databases, etc.). The electronic documents stored in these databases may be organized in a predetermined fashion, which may allow ease of access to the electronic documents and/or any portions thereof. For example, electronic documents stored in these databases may be labeled, searchable, and/or otherwise, easily identifiable. The documents may be stored in a particular electronic format (e.g., PDF, . docx, etc.). The electronic documents may be structured and/or unstructured.

Other data storage sources may be configured to be public non-government databases, government databases (e.g., SEC-EDGAR, etc.), etc. and may store various electronic documents, such as, for example, legal documents (e.g., commercial contracts, lease agreements, public disclosures (e.g., 10k statements, 5k statements, quarterly reports, etc.)), non-legal documents (e.g., articles, books, etc.). The electronic documents stored in these databases may be identified using various identifiers, which may allow location of these documents in the databases, however, contents of electronic documents stored therein might not be parsed and/or specifically identified. For example, a review of the entire electronic document (e.g., 10k statement of a company stored in SEC-EDGAR database) may need to be performed to identify a particular section (e.g., a section related to compensation of executives for the company).

The electronic documents may be any type of documents, such as, for example, agreements, applications, websites, video files, audio files, text files, images, graphics, tables, spreadsheets, computer programs, etc. The documents may be in any desired format, e.g., .pdf, .docx, .xls, and/or any other type of format. The documents may also have any desired size. Moreover, the documents may be organized in any desired fashion. In some examples, documents may be nested within other documents (e.g., one document embedded in another document); one document may be linked to another document, etc.

In some embodiments, electronic documents may include one or more portions. Examples of such portions may include pages, headings, sub-headings, sections, paragraphs, sentences, tables, images, parties, conditions, terms, specific descriptions, and/or any other type of entities. One or more portions may also be associated and/or assigned one or more functions (e.g., a document title, a text heading, a text paragraph, etc.). The documents may be structured in a particular way (e.g., a lease agreement may include a section identifying parties, a section identifying leased premises, a section describing rent being paid, etc.). The documents may also be unstructured.

As shown in FIG. 1, one or more input devices 104 (e.g., input device 1 104a, input device 2 104b, . . . input device N 104c) may be configured to generate one or more requests for performing one or more tasks. The input devices 104 may be any type of computing devices, e.g., mobile devices (e.g., smartphones, tablets, laptops, etc.), stationary computing devices (e.g., personal computers), etc., and/or any other types of computing devices. The task(s) may involve electronic documents, such as, for example, but not limited to generation of electronic documents, management of electronic document, execution (and/or signing) of electronic documents, creation of document workflows, etc. Alternatively, or in addition, tasks may involve execution of one or more software applications (e.g., “apps”, etc.), accessing stored data, etc. The tasks may involve accessing, using, etc. capabilities of another computing system that may store various data, execute applications, etc. related to the requested tasks. Such other computing system may be external to the computing system that the input devices 104 are accessing and may have different computing environment having its system and/or operational requirements, interfaces, preferences, data storages, ways that data is stored and/or accessed, etc. This, in some conventional systems, may require downloading and installing various software applications (e.g., apps, plug-ins, etc.) on the input devices and/or in the computing system that the input devices are interfaces with, and/or interfacing and/or shuttling between two separate computing systems to perform a particular task. To resolve these difficulties, the connected data engine 102 may be configured to provide the input devices 104 with an ability perform such tasks that involve access, use, etc. of capabilities of another computing system without installation of appropriate software, interfaces, etc., or shuttling between two systems, etc. that may be required for performance of such tasks, thereby allowing seamless integration of computing system environments without the burden of either accessing another computing system to retrieve requisite data, applications, etc., and/or installing same in requesting system.

The tasks may be received by the connected data engine 102 and may involve use one or more client application(s) 120. The client application(s) 120 may be document processing applications, tables, signing applications, authentication services, multi-media applications, workflow computing engines, and/or any other type of applications. To perform requested tasks, client application(s) 120 may require use of data, applications, etc., which may be stored and/or otherwise operating in a computing environment of one or more external computing systems. Each such external computing system may be accessible via one or more of its respective external interfaces (e.g., external computing system 1 may be accessible via external interface 1 118a, external computing system 2 may be accessible via external interface 2 118b, . . . , external computing system N may be accessible via external interface N 118c). The interfaces may be application programming interfaces. In some embodiments, one or more external interfaces 118 may be designed to provide access to the entirety of its external computing system, specific layers of the computing system, a specific computing object (e.g., data, application, storage location, etc.) of such external computing system, etc.

For instance, the task(s) may involve generation, negotiation and execution of a lease agreement for a real estate. Generation of the lease agreement may require use of a lease agreement electronic document template that may be stored by another computing system. The lease agreement may require specific data that may be stored in yet another computing system (e.g., a private and/or a public database (e.g., county clerk's office, etc.)). Negotiation of the lease agreement may be performed through an interface that may be provided by yet further computing system. Finally, execution of the lease agreement may require a signature application that may be available from another different computing system. The current subject matter may be configured to generate connection interfaces to allow the user of the input device that generated the request for execution of these tasks to be able to connect with all of these systems and use their capabilities, data, etc. without being required to separately access these computing system and/or install their specific software, interfaces, etc.

Upon receiving the task(s) from the input device(s) 104, the connected data engine 102 may be configured to determine which computing systems may need to be accessed for the purposes of completing the task(s). For example, the connected data engine 102 may determine that the task(s) may involve one or more sub-task(s), each of which may need to be executed using capabilities, data, etc. of separate external computing systems. To do so, the connected data engine 102 may use one or more interface(s) 108 (e.g., read interface, write interface, management interface) along with data routing engine 110 and/or data capture engine 112 to analyze the received task(s) and determine how task(s) need to be executed. The data capture engine 112 may be configured capture data that may be related to the received task(s), e.g., by analyzing the task(s) (e.g., using natural language processing) to determine which specific data may be needed for completion of the task(s), which computing systems may need to be accessed, which application(s) may need to be executed, etc. The data routing engine 110 may be configured to route the information determined from the received task(s) to an appropriate destination (e.g., connection engine 114, model registry 106, etc.).

In some embodiments, upon analyzing the received task(s), the connected data engine 102 may be configured to retrieve and/or generate one or more connection data model(s) from the model registry 106. The connection data model(s) may be specific to an external computing system (e.g., external computing system's computing environment, applications, data, capabilities, etc.) used to generate one or more connection interface(s) 116 by the connection engine 114. The connected data engine 102 may be configured to generate connection data model dynamically and/or in real-time, e.g., upon receiving a request for execution of one or more task(s) and/or it may retrieve previously generated connection data model. Previously generated connection data model may have been generated by the connected data engine 102 based on prior connections with external computing systems using one or more connection parameters stored in the storage location 122, which, in turn, may have been obtained from the external computing system.

The connection data model(s) may define how connections between two or more computing systems may be configured and how users of input devices 104 may be able to access data, applications, capabilities, etc. of external computing systems while operating in computing environments of their computing systems. The connection data model(s) may also define how one or more connection interface(s) 116 may be generated by the connection engine 114 so that such connections between computing systems may be formed. The connection data models may be generated based on one or more connection parameters. The connection parameter(s) may be provided by the external computing systems to ensure that connections via external computing systems'corresponding external interfaces 118 may be configured and take place. The parameters may be extracted from the storage location 122, where such parameters may be stored after being received from the external computing systems. The parameters may also be received in real-time, e.g., upon the connected data engine 102 receiving a request from the input device(s) 104. For instance, the receipt of the request from the input device(s) 104 may trigger the connected data engine 102 to check whether one or more connection data models are already stored in the model registry 106 and if not, whether appropriate connection parameters are stored in the storage location 122. If such parameters are stored, then the connected data engine 102 may generate one or more connection data models for the purposes of generating one or more connection interface(s) 116 by the connection engine 114. As discussed herein, the connection data models may be specific to particular connections between computing systems and/or specific task(s). Alternatively, or in addition, the connection data models may be generic to ensure that connections between computing systems may always exist through its connection interface(s) 116. If no parameters are stored in the storage location 122, the connected data engine 102 may be configured to request the external computing system with which connection is sought, the parameters for forming one or more connection interface(s) 116. Once such parameters are received, the connected data engine 102 may generate a connection data model and store same in the model registry 106. The received parameters may also be stored in the storage location 122. The stored connection data model and/or the stored parameters may be used for the purposes of generating one or more connection interface(s) 116 when future requests from input device(s) 104 are received.

Once connection data model is generated, it may be provided to the connection engine 114 to generate one or more connection interface(s) 116. The connection interface(s) 116 may serve as connection interfaces with external computing system via their respective external interface(s) 118. Both connection interface(s) 116 and/or external interface(s) 118 may be application programming interface, where connection through such interfaces may be governed by various protocols, rules, and/or any other factors, parameters, etc. One or more connection interface(s) 116 may connect to one or more external interfaces 118. For example, a single connection interface 116 may connect to multiple external interfaces 118 (e.g., external interface 1 118a and external interface 2 118b), and vice versa. An external computing system may have a single external interface or multiple external interfaces with which the connection interface(s) 116 may connect.

The connections formed between connection interface(s) 116 and external interface(s) 118 may allow users of input devices 104 to perform tasks that they request. For example, as discussed above, users may use computing environments of their system and data, templates, applications, etc. of one or more external computing systems to generate, negotiate, and execute a lease agreement. A single and/or separate connections (each of which may be defined by a single and/or separate connection data models) may be formed through connection interface(s) 116 and external interface(s) 118 for each of the generation of the lease agreement, negotiation of the lease agreement, and execution. Using such connections, the input device(s) 104 may issue queries, requests, etc., which the connection interface(s) 116 may translate into the format, language, etc. that is readable or understandable by the external computing systems, which the translated queries, requests, etc. are then transmitted via the formed connections.

For instance, a connection formed between connection interface(s) 116 and external interface 1 118a associated with a computing system having lease agreement templates may be used for the purposes of accessing, by the input device(s) 104, an appropriate lease agreement template. To do so, a request for the template from the computing device 104 (and/or as determined by the connected data engine 102) may be translated by the connection interface(s) 116 and transmitted via the external interface 1 118a to the external computing system storing such templates. Same and/or another connection (with the same and/or different external computing system) may be used to retrieve data, clauses, and/or any other information for insertion into the retrieved templates. Same or different request, query, etc. may be issued, translated, and then transmitted through the connection(s) formed between the connection interface(s) 116 and one or more of the external interface(s) 118 (e.g., external interface 2 118b). Once lease agreement is generated and negotiated, it may be signed by the parties to such agreement. Another connection may be formed between connection interface(s) 116 and, for example, external interface N 118c, which may be associated with an external computing system that has electronic signing capabilities. As discussed herein, each connection may be defined by the same and/or different connection data model(s), which may be specific to particular request(s) from the input device(s) 104, particular task(s) and/or sub-task(s) (e.g., generation of a lease agreement, negotiation of the lease agreement, and/or a signing of the lease, etc.), and/or particular external computing system(s). Each connection data model(s) may, in turn, be defined by the same and/or different connection parameters, which, again, may be specific to particular request(s) from the input device(s) 104, particular task(s) and/or sub-task(s), and/or particular external computing system(s).

Upon receiving the request(s), quer(ies), etc. via the connections between connection interface(s) 116 and external interface(s) 118, the external computing systems may generate appropriate responses, which may be transmitted back via the same and/or different connections (e.g., one connection may be formed for transmission of a request to the external computing system and another connection may be formed for transmission of a response to the request). The response may be translated by the connection interface(s) 116 in accordance with the connection data model and provided to the requesting input device(s) 104 (and/or client application(s) 120, which may be running on the requesting input device(s) 104). As discussed herein, the connection data model may be an existing connection data model and/or a connection data model that may dynamically be generated for the purposes of handling the specific request(s), quer(ies), translations, and/or transmissions thereof, etc. The connection data model may be configured to merge various requirements, parameters, schemas, constraints, etc. associated with specific computing systems that are being connected by the connection interface formed using the connection model, specific request(s), quer(ies), etc. and/or any other factors. The translation and transmission of requests and responses may continue until completion of the tasks requested by the input device(s) 104. Any data generated as a result of such translations, transmission, etc. that are performed as part of task execution may be stored in one or more of the model registry 106, storage location 122, and/or any other storage location. Such storage locations may be searchable to provide for an ability to access data that have resulted from historical executions of tasks.

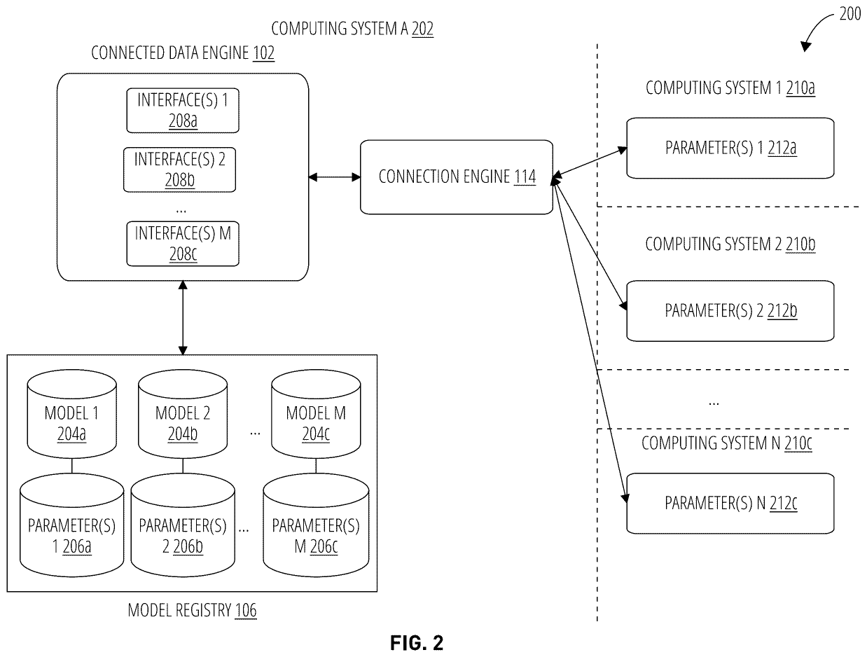

FIG. 2 illustrates an example connection system 200, according to some embodiments of the current subject matter. The connection system 200 may include a computing system A 202 and a plurality of computing systems 210 (a, b, . . . , c) (e.g., computing system 1 210a, computing system 2 210b, . . . , computing system N 210c), which may be computing systems that are external to the computing system A 202 and may be communicatively coupled to the computing system A 202 using any desired communication connections (e.g., wired, wireless, etc.). The computing system A 202 and the external computing systems 210 may be connectable using connection engine 114. The systems 202 and 210 may be connected for the purposes of enabling use of various data, applications, capabilities, etc. of one or more computing systems 210 by the users of the computing system A 202 for the purposes of performing various tasks (e.g., generating, negotiating, and signing of a lease agreement, etc.).

The computing system A 202 may include connected data engine 102 and model registry 106. The computing system A 202 may also include the connection engine 114. Alternatively, or in addition, the connection engine 114 may be separately located from the computing system A 202. The model registry 106 may include one or more interfaces 1, 2, . . . , M 208 (a, b, . . . , c) that may be generated and/or used in connection with one or more connection data models 1, 2, . . . , M 204 (a, b, . . . , c) stored in the model registry 106. The interfaces 208 may be used for reading, writing, and/or management of data and/or requests associated with tasks that may be received from users (e.g., input devices 104 as shown in FIG. 1) of computing system A 202.

The connection data model(s) 204 may be generated using one or more connection parameters 1, 2, . . . , M 206 (a, b, . . . , c). Each connection data model 204 may be generated using a single parameter 206 (e.g., parameter(s) 1 206a) and/or multiple parameters 206 (e.g., parameter(s) 2 206b and parameter(s) M 206c). The parameters 206 may correspond to one or more parameters 212 (a, b, . . . , c) associated with one or more external computing systems 210. The connection data model(s) 204 may be generated based on a particular task or tasks (e.g., generation, negotiation, and signing of a lease agreement) that may be received from the user(s) of the computing system A 202. Alternatively, or in addition, the connection data model(s) 204 may be generated based on a particular external system and/or systems 210, e.g., a connection data model 1 204a may be generated for connection to computing system 1 210a. If the connection data model 204 is generated for connecting to a particular external computing system 210, any connection interfaces generated by the connection engine 114 based on such connection data model may be used for performance of multiple different tasks received from one or more input devices 104 (as shown in FIG. 1).

Each connection data model 204 may be generated based on connection parameters 212 that are specific to a particular external computing system 210. For example, connection data model for generation of a connection interface (by the connection engine 114) with the computing system 1 210a may be generated using its parameter(s) 1 212a (one or more parameters 212a may be used for the purposes of generating connection data model). Connection para meter(s) 2 212b may be used for generation of a connection data model for connecting with the computing system 2 210b. More than one connection data model may be generated for connection with a specific external computing system. Each such connection data model may be used to generate one or more connection interfaces by the connection engine 114 to connection with external computing system. For example, connection data models 204a and 204b may be used by the connection engine 114 to generate a connection interface with the computing system 1 210a. Further, different connection parameters 212a may be used for generation of different connection data models (e.g., model 1 204a and model 2 204b), which, in turn, may be used to generate a single and/or multiple connection interfaces with the computing system 1 210a. Moreover, a single connection data model (e.g., model 1 204a) may be used to generate connection interfaces with multiple external computing systems (e.g., computing system 1 210a, computing system 2 210b, . . . , computing system N 210c). A single connection interface may likewise be generated using a single and/or multiple connection data models for connection to a single and/or multiple external computing systems. In some embodiments, connection data models may define connection interfaces that may provide connections between computing system A 202 and multiple external systems 210, where external systems 210 may use the connection interface to communicate with one another for the purposes of providing responses to received request. Thus, the connection interface may provide connections, and, hence, translations of queries, requests, responses, etc. not only between computing system A 202 and one or more external systems 210, but also between external systems 210.

In the lease agreement example above, the connection data model 1 204a may be generated in response to a receiving a request from an input device (as shown in FIG. 1) to generate, negotiate, and sign a lease agreement. The computing system A 202 may determine connections to external computing system 1 210a, computing system 2 210b, and computing system N 210c may be required for the purposes of executing this request. For instance, computing system 1 210a may include one or more lease agreement templates that have various fields into which values may be inserted (e.g., party name(s), property address, etc.), whereas computing system 2 210b may store various data values that may be accessed by the lease agreement template. For instance, the computing system 2 210b may be a government database that stores property addresses, tax ID information, etc. The connection formed by the connection interface may allow external computing systems 210a, 210b as well as computing system A 202 to communicate with one another via various requests, queries, etc. and provide responses to such requests, queries, etc., so that data from databases in computing system 2 210b may be queried and retrieved for insertion into the lease agreement template received from the computing system 1 210a. Alternatively, or in addition, the external systems 210 do not communicate with one another and instead, provide responses to the computing system A 202, which may be configured to generate and send separate requests to each external computing system 210 for data, information, executables, etc. that are specific to that system.

As a result of these communications among computing systems, the lease agreement electronic document may be generated and be presented to the parties for signature. The same connection interfaces may be used to connect to another external computing system, e.g., computing system N 210c, for the purposes of signing of the lease agreement. The computing system N 210c may be configured to verify and authenticate signatures of parties to the lease agreement and generate, for example, an electronic log and/or requisite metadata associated with the signing, which may be stored in a storage location (e.g., a distributed ledger, a blockchain, etc.).

Alternatively, or in addition, a separate connection interface may be generated for connecting to the computing system N 210c. This connection interface may be generated based on an existing connection data model and/or a connection data model that may be dynamically/real-time generated for the purposes of the signature. The connection data model (whether existing or dynamically/real-time generated) may be generated based on parameter(s) N 212c that may be provided by the computing system N 210c to the computing system A 202.

In some embodiments, the computing system A 202 may store connection data models in the model registry 106. The computing system A 202 may also update such stored connection data models upon receipt of updated connection model parameters and/or any other data, metadata, information, etc. The system 202 may also store connection model parameters. This may also the system 202 to generate and/or re-generate connection data models when necessary. The system 202 may also store data, information, etc. associated with connection interfaces generated by the connection engine 114 based on the stored connection data models. The connection data models, connection data model parameters, connection interfaces, and/or any data, metadata, information, etc. associated therewith may be stored in any desired format, e.g., in tree-like structure format, in column-based format, in code, etc.

Alternatively, or in addition, connection data models and/or corresponding connection interfaces may be temporarily generated for the purposes of completing a specific request, task, sub-task, etc. Once such request, task, sub-task, etc. has been completed, the connection data models and/or corresponding connection interfaces may be discarded. New connection data model(s) and/or corresponding connection interface(s) may be generated upon receipt of a new request from an input device 104 (as shown in FIG. 1). Connection interfaces (which may include application programming interfaces and/or any other type of interfaces) may be generated in any desired way to ensure that translation of requests to external system and responses is accurately performed.

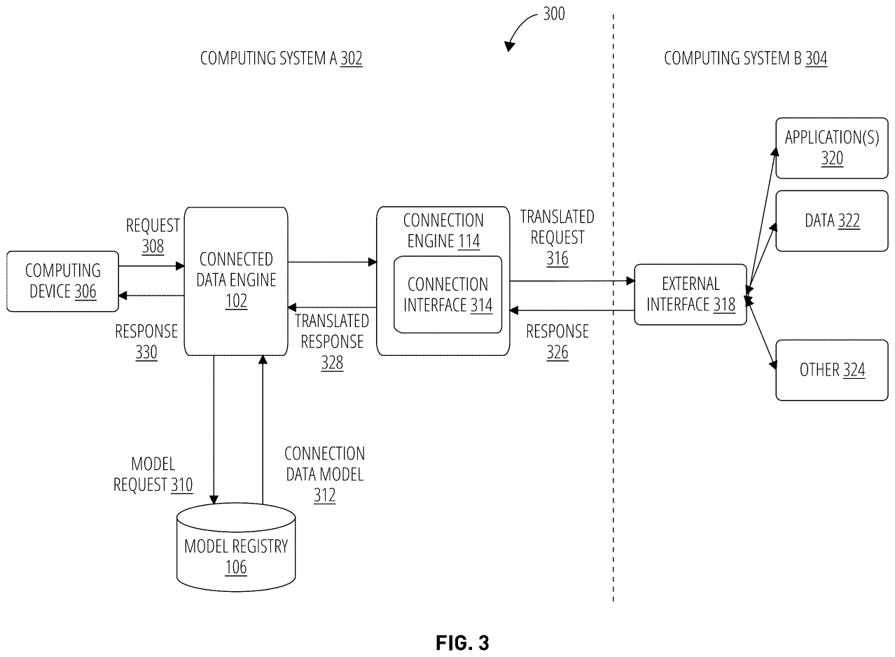

FIG. 3 illustrates an example connection system 300, according to some embodiments of the current subject matter. The connection system 300 may provide connection, using one or more connection interfaces, between computing system A 302 and computing system B 304. The computing system B 304 may be external to the computing system A 302. Each computing system may have its own computing environments, requirements, software applications, data storages, data, etc. The users of one system (e.g., computing system A 302) may wish to access data, applications, etc. of another system (e.g., computing system B 304) for completion of various computing tasks (e.g., generation, negotiation, and signing of an electronic lease agreement).

The computing system A 302 may include a computing device 306 (e.g., a mobile device, a stationary computing device, etc.), the connected data engine 102, and the model registry 106 among its various other computing components (not shown in FIG. 3). The computing system A 302 may also include and/or be communicatively coupled to the connection engine 114. In some embodiments, a user of the computing device 306 may generate a request 308. The request 308 may be received by the computing system A 302 and processed by the connected data engine 102. The request 308 may also include one or more tasks, sub-tasks, etc.

The connected data engine 102 may determine that for completion of the request, a connection with the computing system B 304 may need to be established. For example, in the lease agreement example, various computing objects (e.g., lease agreement template(s), etc.), data (e.g., data values containing information about real property being leased, etc.), software applications (e.g., signature application, data and/or signature verification and/or authentication application(s), etc.), etc. may need to be accessed within the computing system B 304 for the purposes of generating the electronic lease agreement document, negotiating it and signing it. The connected data engine 102 may generate a model request 310 to the model registry 106 to determine whether connection data model has already been generated for the purposes of generating and/or defining a connection interface 314 between computing system A 302 and computing system B 304. The connection data model may be generated using one or more connection parameters associated with the computing system B 304, which may define various requirements of accessing data, application, etc. of the computing system B 304, and thus, define how the connection interface 314 may need to be generated using connection data model.

If the requested connection data model has already been generated and stored in the model registry 106, the specific connection data model 312 may be returned to the connected data engine 102. Otherwise, one can be generated based on the parameters associated with the computing system B 304. The connection data model 312 may then be provided to the connection engine 114, which may use the connection data model 312 to generate connection interface 314. The connection interface 314 may then translate the request 308 into a translated request 316 and provide it, via external interface 318 of the computing system B 304, to the computing system B 304. Translation of the request 308 into the translated request 316 may ensure that the computing system B 304 is able to understand the request 308 and provide an appropriate response 326. The response 326 may include providing access to one or more application(s) 320 (e.g., lease agreement template application), data 322 (e.g., real estate records database, etc.), and/or any other information, data, etc. 324.

The response 326 may be received by the connection interface 314 and translated into a translated response 328. Similarly, translation of the response 326 into the translated response 328 may ensure that the computing system A 302 is able to understand the response 326, where the response may be provided, as response(s) 330, to the computing device 306. For example, the responses 330 may be in a form of a lease agreement template being displayed on a graphical user interface of the computing device 306 and data values appearing and/or being selectable in various fields of the template. The response(s) 330 may also be in response to the user selecting a specific field in the template and selecting a particular value from a drop-down list, all of which may be provided as real-time responses from the computing system B 304, thereby providing user of the computing device 306 with a “feel” that the user is operating within the computing system A 302 while seamlessly accessing computing system B 304.

In some embodiments, any of the requests and/or corresponding responses along with connection data model 312 and/or connection interface 314 may be stored in a storage location of the computing system A 302. The stored connection data model 312 and/or connection interface 314 (with and/or without requests and/or responses) may be accessed by the computing system A 302 each time a new request is received and/or prior request is revisited by the user of the computing device 306. Further connection data models may be accessed to generate additional connection interfaces with the same computing system B 304 and/or a different external computing system.

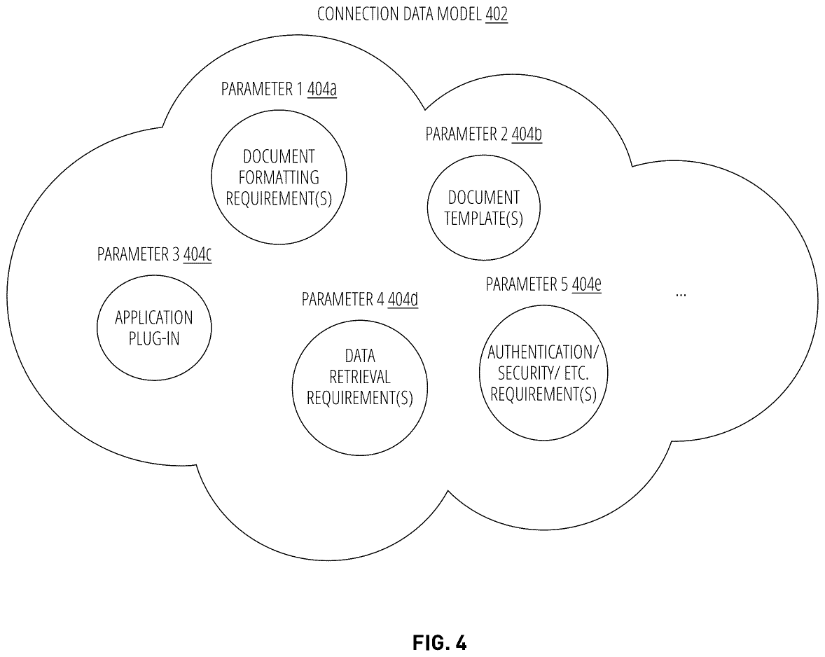

FIG. 4 illustrates an example connection data model 402, according to some embodiments of the current subject matter. The connection data model 402 may, for example, be used for connection generation of a connection interface between computing system A 302 and computing system B 304. As can be understood the connection data model 402 can be used for generation of a connection interface between any computing systems, so as to provide users of such computing system(s) an ability to execute any desired tasks, which may involve, but are not limited to, for example, accessing data, using software applications that may be native to a specific computing system, etc.

The connection data model 402 may be generated based on one or more parameters 1, 2, 3, 4, 5, . . . 404 (a, b, c, d, e, . . . ). Each parameter 404 may define specific aspects of connection interface between two computing systems that may define how requests and/or responses exchanged between systems may be handled, including, their translation, transmission, etc. The parameters may also be specific to particular requests, tasks, sub-tasks, etc.

In the lease agreement example, parameter 1 404a may define various document formatting requirements of a lease agreement (e.g., arrangement of sections of the lease agreement in a particular way, etc.). Parameter 2 404b may define aspects of a template that may be available from an external computing system (e.g., computing system B 304 as shown in FIG. 3) and that may be used for generation of an electronic lease agreement. Parameter 3 404c may define requirements and/or preferences associated with a particular application plug-in that may be available from an external computing system (e.g., for the purposes of using external computing system's application from user's internet browser, etc.). Parameter 4 404d may be indicative of various data retrieval requirements associated with an external system (e.g., real estate records stored in a government database, etc.) Parameter 5 404e may identify various authentication, security, etc. requirements associated with connections between computing systems (e.g., two-step authentication, data verification, etc.). As can be understood, any other parameters may be used to generate the connection data model 402, which, in turn, may then be used to define one or more connection interfaces.

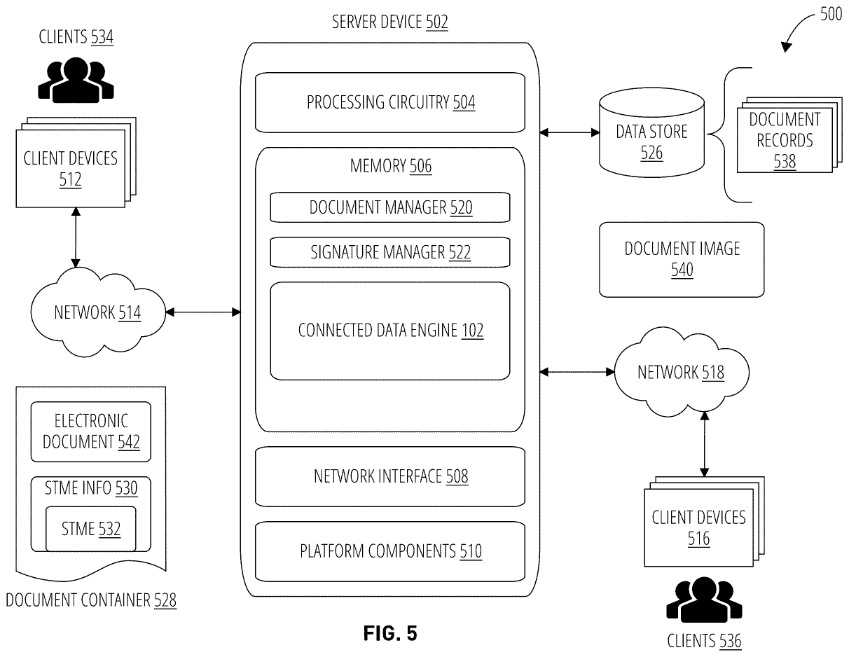

FIG. 5 illustrates an embodiment of a system 500 where connected data engine 102 may be implemented. The system 500 may be suitable for implementing one or more embodiments as described herein. By way of a non-limiting example, the system 500 may comprise an electronic document management platform (EDMP) suitable for managing a collection of electronic documents. An example of an EDMP includes a product or technology offered by DocuSign®, Inc., located in San Francisco, California (“DocuSign”). DocuSign is a company that provides electronic signature technology and digital transaction management services for facilitating electronic exchanges of contracts and signed documents. An example of a DocuSign product is a DocuSign Agreement Cloud that is a framework for generating, managing, signing and storing electronic documents on different devices. It may be appreciated that the system 500 may be implemented using other EDMP, technologies and products as well. For example, the system 500 may be implemented as an online signature system, online document creation and management system, an online workflow management system, a multi-party communication and interaction platform, a social networking system, a marketplace and financial transaction management system, a customer record management system, and other digital transaction management platforms. Embodiments are not limited in this context.

The system 500 may implement an EDMP as a cloud computing system. Cloud computing is a model for providing on-demand access to a shared pool of computing resources, such as servers, storage, applications, and services, over the Internet. Instead of maintaining their own physical servers and infrastructure, companies can rent or lease computing resources from a cloud service provider. In a cloud computing system, the computing resources are hosted in data centers, which are typically distributed across multiple geographic locations. These data centers are designed to provide high availability, scalability, and reliability, and are connected by a network infrastructure that allows users to access the resources they need. Some examples of cloud computing services include Infrastructure-as-a-Service (IaaS), Platform-as-a-Service (PaaS), and Software-as-a-Service (SaaS).

The system 500 may implement various search tools and algorithms designed to search for electronic document(s) and/or collections of electronic documents (which may also be referred to as “transaction documents”, “transaction packages”, “document packages” or “packages”) and/or information within an electronic document or across a collection of electronic documents. Within the context of a cloud computing system, the system 500 may implement a cloud search service accessible to users via a web interface or web portal front-end server system. A cloud search service is a managed service that allows developers and businesses to add search capabilities to their applications or websites without the need to build and maintain their own search infrastructure. Cloud search services typically provide powerful search capabilities, such as faceted search, full-text search, and auto-complete suggestions, while also offering features like scalability, availability, and reliability. A cloud search service typically operates in a distributed manner, with indexing and search nodes located across multiple data centers for high availability and faster query responses. These services typically offer application program interfaces (APIs) that allow developers to easily integrate search functionality into their applications or websites. One major advantage of cloud search services is that they are designed to handle large-scale data sets and provide powerful search capabilities that can be difficult to achieve with traditional search engines. Cloud search services can also provide advanced features, such as machine learning-powered search, natural language processing, and personalized recommendations, which can help improve the user experience and make search more efficient. Some examples of popular cloud search services include Amazon CloudSearch, Elasticsearch, and Azure Search. These services are typically offered on a pay-as-you-go basis, allowing businesses to pay only for the resources they use, making them an affordable option for businesses of all sizes.

In general, the system 500 may allow users to generate, revise and electronically sign electronic documents. When implemented as a large-scale cloud computing service, the system 500 may allow entities and organizations to amass a significant number of electronic documents, including both signed electronic documents and unsigned electronic documents. As such, the system 500 may need to manage a large collection of electronic documents for different entities, a task that is sometimes referred to as contract lifecycle management (CLM).

As shown in FIG. 5, the system 500 may include a server device 502 communicatively coupled to a set of client devices 512 via a network 514. The server device 502 may also be communicatively coupled to a set of client devices 516 via a network 518. The client devices 512 may be associated with a set of clients 534. The client devices 516 may be associated with a set of clients 536. In one network topology, the server device 502 may represent any server device, such as a server blade in a server rack as part of a cloud computing architecture, while the client devices 512 and the client devices 516 may represent any client device, such as a smart wearable (e.g., a smart watch), a smart phone, a tablet computer, a laptop computer, a desktop computer, a mobile device, and so forth. The server device 502 may be coupled to a local or remote data store 526 to store document records 538. It may be appreciated that the system 500 may have more or less devices than shown in FIG. 5 with a different network topology as needed for a given implementation. Embodiments are not limited in this context.

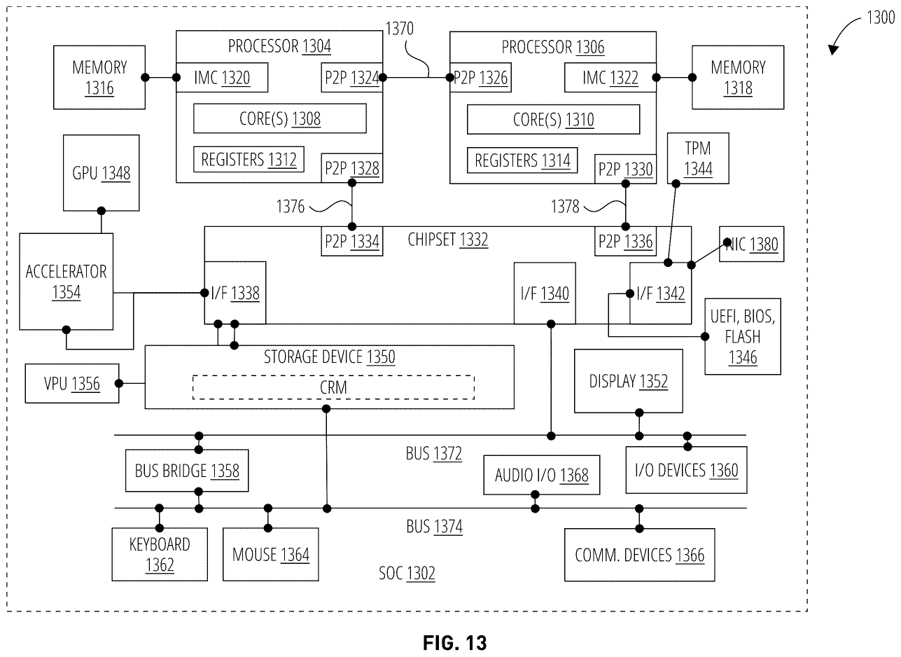

In various embodiments, the server device 502 may include various hardware elements, such as a processing circuitry 504, a memory 506, a network interface 508, and a set of platform components 510. The client devices 512 and/or the client devices 516 may include similar hardware elements as those depicted for the server device 502. The server device 502, client devices 512, and client devices 516, and associated hardware elements, are described in more detail with reference to a computing architecture 1300 as depicted in FIG. 13.

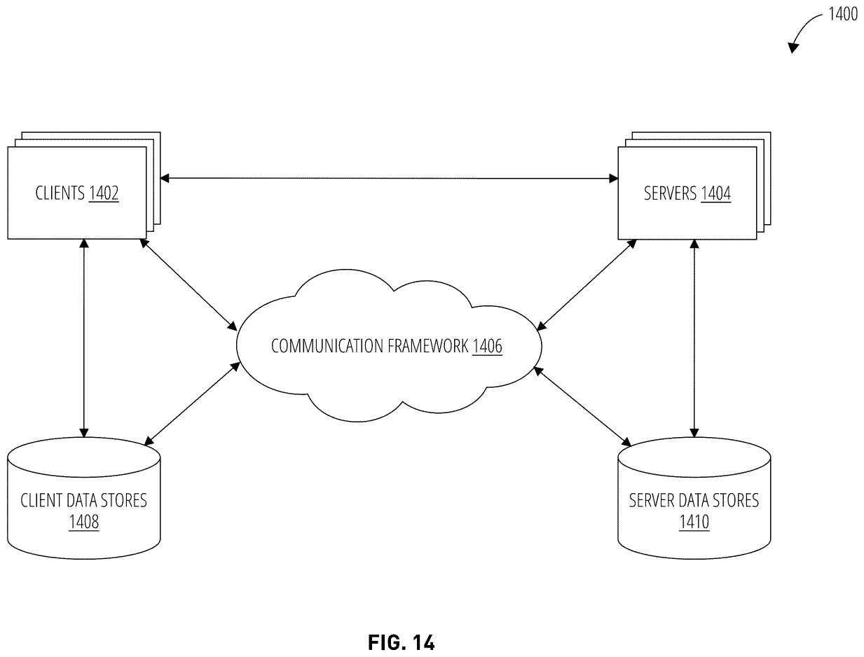

In various embodiments, the server devices 502, 512 and/or 516 may communicate various types of electronic information, including control, data and/or content information, via one or both network 514, network 518. The network 514 and the network 518, and associated hardware elements, are described in more detail with reference to a communications architecture 1400 as depicted in FIG. 14.

The memory 506 may store a set of software components, such as computer executable instructions, that when executed by the processing circuitry 504, causes the processing circuitry 504 to implement various operations for an electronic document management platform. As depicted in FIG. 5, for example, the memory 506 may include a document manager 520, a signature manager 522, and a document generation engine 550, among other software elements.

The document manager 520 may generally manage a collection of electronic documents stored as document records 538 in the data store 526. The document manager 520 may receive as input a document container 528 for an electronic document. A document container 528 is a file format that allows multiple data types to be embedded into a single file, sometimes referred to as a “wrapper” or “metafile.” The document container 528 can include, among other types of information, an electronic document 542 and metadata for the electronic document 542.

A document container 528 may include an electronic document 542. The electronic document 542 may comprise any electronic multimedia content intended to be used in an electronic form. The electronic document 542 may comprise an electronic file having any given file format. Examples of file formats may include, without limitation, Adobe portable document format (PDF), Microsoft Word, PowerPoint, Excel, text files (.txt, .rtf), and so forth. In one embodiment, for example, the electronic document 542 may comprise a PDF created from a Microsoft Word file with one or more workflows developed by Adobe Systems Incorporated, an American multi-national computer software company headquartered in San Jose, California. Embodiments are not limited to this example.

In addition to the electronic document 542, the document container 528 may also include metadata for the electronic document 542. In one embodiment, the metadata may comprise signature tag marker element (STME) information 132 for the electronic document 542. The STME information 530 may include one or more STME 532, which are graphical user interface (GUI) elements superimposed on the electronic document 542. The GUI elements may include textual elements, visual elements, auditory elements, tactile elements, and so forth. In some embodiments, for example, the STME information 530 and STME 532 may be implemented as text tags, such as DocuSign anchor text, Adobe® Acrobat Sign® text tags, and so forth. Text tags are specially formatted text that can be placed anywhere within the content of an electronic document specifying the location, size, type of fields such as signature and initial fields, checkboxes, radio buttons, and form fields; and advanced optional field processing rules. Text tags can also be used when creating PDFs with form fields. Text tags may be converted into signature form fields when the document is sent for signature or uploaded. Text tags can be placed in any document type such as PDF, Microsoft Word, PowerPoint, Excel, and text files (.txt, .rtf). Text tags offer a flexible mechanism for setting up document templates that allow positioning signature and initial fields, collecting data from multiple parties within an agreement, defining validation rules for the collected data, and adding qualifying conditions. Once a document is correctly set up with text tags it can be used as a template when sending documents for signatures ensuring that the data collected for agreements is consistent and valid throughout the organization.

In one embodiment, the STME 532 may be utilized for receiving signing information, such as GUI placeholders for approval, checkbox, date signed, signature, social security number, organizational title, and other custom tags in association with the GUI elements contained in the electronic document 542. A client 534 may have used the client device 512 and/or the server device 502 to position one or more signature tag markers over the electronic document 542 with tools applications, and workflows developed by DocuSign or Adobe. For instance, assume the electronic document 542 is a commercial lease associated with STME 532 designed for receiving signing information to memorialize an agreement between a landlord and tenant to lease a parcel of commercial property. In this example, the signing information may include a signature, title, date signed, and other GUI elements.

The document manager 520 may process a document container 528 to generate a document image 540. The document image 540 is a unified or standard file format for an electronic document used by a given EDMP implemented by the system 500. For instance, the system 500 may standardize use of a document image 540 having an Adobe portable document format (PDF), which is typically denoted by a “.pdf” file extension. If the electronic document 542 in the document container 528 is in a non-PDF format, such as a Microsoft Word “.doc” or “.docx” file format, the document manager 520 may convert or transform the file format for the electronic document into the PDF file format. Further, if the document container 528 includes an electronic document 542 stored in an electronic file having a PDF format suitable for rendering on a screen size typically associated with a larger form factor device, such as a monitor for a desktop computer, the document manager 520 may transform the electronic document 542 into a PDF format suitable for rendering on a screen size associated with a smaller form factor device, such as a touch screen for a smart phone. The document manager 520 may transform the electronic document 542 to ensure that it adheres to regulatory requirements for electronic signatures, such as a “what you see is what you sign” (WYSIWYS) property, for example.

The signature manager 522 may generally manage signing operations for an electronic document, such as the document image 540. The signature manager 522 may manage an electronic signature process to send the document image 540 to signers, obtaining electronic signatures, verifying electronic signatures, and recording and storing the electronically signed document image 540. For instance, the signature manager 522 may communicate a document image 540 over the network 518 to one or more client devices 516 for rendering the document image 540. A client 536 may electronically sign the document image 540 and send the signed document image 540 to the server device 502 for verification, recordation, and storage.

The engine 550 may also implement and/or manage various artificial intelligence (AI) and/or machine learning (ML) agents to assist in various operational tasks for the EDMP of the system 500. The AI/ML agents and their operation associated with the document generation engine 550, and associated software elements. The document generation engine 550, and associated hardware elements, are described in more detail with reference to a computing architecture 1300 as depicted in FIG. 13.

In general operation, assume the server device 502 receives a document container 528 from a client device 512 over the network 514. The server device 502 processes the document container 528 and makes any necessary modifications or transforms as previously described to generate the document image 540. The document image 540 may have a file format of an Adobe PDF denoted by a “.pdf” file extension. The server device 502 sends the document image 540 to a client device 516 over the network 518. The client device 516 renders the document image 540 with the STME 532 in preparation for electronic signing operations to sign the document image 540.

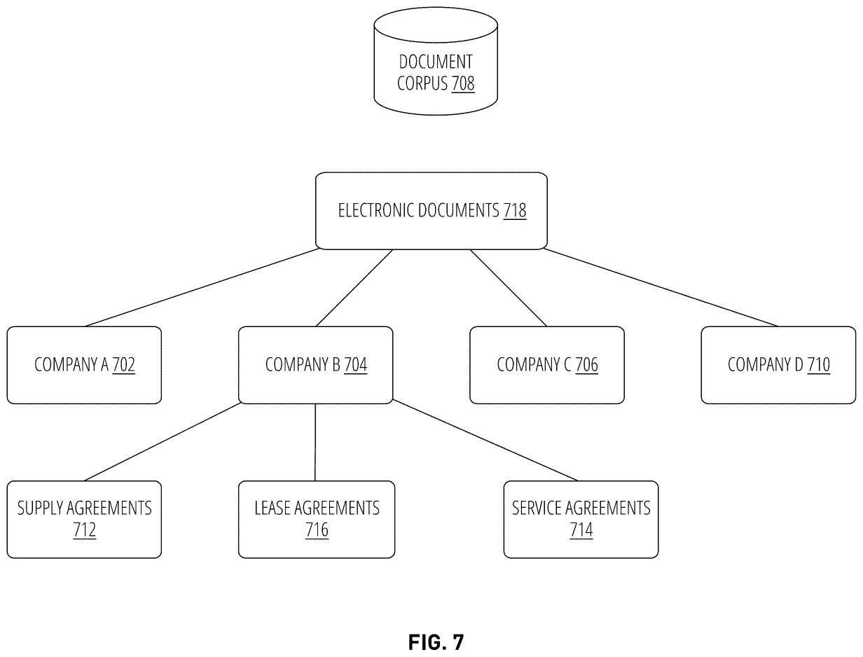

The document image 540 may further be associated with STME information 530 including one or more STME 532 that were positioned over the document image 540 by the client device 512 and/or the server device 502. The STME 532 may be utilized for receiving signing information (e.g., approval, checkbox, date signed, signature, social security number, organizational title, etc.) in association with the GUI elements contained in the document image 540. For instance, a client 534 may use the client device 512 and/or the server device 502 to position the STME 532 over the electronic documents 718, as shown in FIG. 7, with tools, applications, and workflows developed by DocuSign, Inc. For example, the electronic documents 718 may be a commercial lease that is associated with one or more or more STME 532 for receiving signing information to memorialize an agreement between a landlord and tenant to lease a parcel of commercial property. For example, the signing information may include a signature, title, date signed, and other GUI elements.

Broadly, a technological process for signing electronic documents may operate as follows. A client 534 may use a client device 512 to upload the document container 528, over the network 514, to the server device 502. The document manager 520, at the server device 502, receives and processes the document container 528. The document manager 520 may confirm or transform the electronic document 542 as a document image 540 that is rendered at a client device 516 to display the original PDF image including multiple and varied visual elements. The document manager 520 may generate the visual elements based on separate and distinct input including the STME information 530 and the STME 532 contained in the document container 528. In one embodiment, the PDF input in the form of the electronic document 542 may be received from and generated by one or more workflows developed by Adobe Systems Incorporated. The STME 532 input may be received from and generated by workflows developed by DocuSign. Accordingly, the PDF and the STME 532 are separate and distinct input as they are generated by different workflows provided by different providers.

The document manager 520 may generate the document image 540 for rendering visual elements in the form of text images, table images, STME images and other types of visual elements. The original PDF image information may be generated from the document container 528 including original documents elements included in the electronic document 542 of the document container 528 and the STME information 530 including the STME 532. Other visual elements for rendering images may include an illustration image, a graphic image, a header image, a footer image, a photograph image, and so forth.

The signature manager 522 may communicate the document image 540 over the network 518 to one or more client devices 516 for rendering the document image 540. The client devices 516 may be associated with clients 536, some of which may be signatories or signers targeted for electronically signing the document image 540 from the client 534 of the client device 112. The client device 112 may have utilized various workflows to identify the signers and associated network addresses (e.g., email address, short message service, multimedia message service, chat message, social message, etc.). For example, the client 534 may utilize workflows to identify multiple parties to the lease including bankers, landlord, and tenant. Further, the client 534 may utilize workflows to identify network addresses (e.g., email address) for each of the signers. The signature manager 522 may further be configured by the client 534 whether to communicate the document image 540 in series or parallel. For example, the signature manager 522 may utilize a workflow to configure communication of the document image 540 in series to obtain the signature of the first party before communicating the document image 540, including the signature of the first party, to a second party to obtain the signature of the second party before communicating the document image 540, including the signature of the first and second party to a third party, and so forth. Further for example, the client 534 may utilize workflows to configure communication of the document image 540 in parallel to multiple parties including the first party, second party, third party, and so forth, to obtain the signatures of each of the parties irrespective of any temporal order of their signatures.

The signature manager 522 may communicate the document image 540 to the one or more parties associated with the client devices 516 in a page format. Communicating in page format, by the signature manager 522, ensures that entire pages of the document image 540 are rendered on the client devices 516 throughout the signing process. The page format is utilized by the signature manager 522 to address potential legal requirements for binding a signer. The signature manager 522 utilizes the page format because a signer is only bound to a legal document that the signer is intended to be bound. To satisfy the legal requirement of intent, the signature manager 522 generates PDF image information for rendering the document image 540 to the one or more parties with a “what you see is what you sign” (WYSIWYS) property. The WYSIWYS property ensures the semantic interpretation of a digitally signed message is not changed, either by accident or by intent. If the WYSIWYS property is ignored, a digital signature may not be enforceable at law. The WYSIWYS property recognizes that, unlike a paper document, a digital document is not bound by its medium of presentation (e.g., layout, font, font size, etc.) and a medium of presentation may change the semantic interpretation of its content. Accordingly, the signature manager 522 anticipates a possible requirement to show intent in a legal proceeding by generating original PDF image information for rendering the document image 540 in page format. The signature manager 522 presents the document image 540 on a screen of a display device in the same way the signature manager 522 prints the document image 540 on the paper of a printing device.

As previously described, the document manager 520 may process a document container 528 to generate a document image 540 in a standard file format used by the system 500, such as an Adobe PDF, for example. Additionally, or alternatively, the document manager 520 may also implement processes and workflows to prepare an electronic document 542 stored in the document container 528. For instance, assume a client 534 uses the client device 512 to prepare an electronic document 542 suitable for receiving an electronic signature, such as the lease agreement in the previous example. The client 534 may use the client device 512 to locally or remotely access document management tools, features, processes and workflows provided by the document manager 520 of the server device 502. The client 534 may prepare the electronic document 542 as a brand new originally written document, a modification of a previous electronic document, or from a document template with predefined information content. Once prepared, the signature manager 522 may implement electronic signature (e-sign) tools, features, processes and workflows provided by the signature manager 522 of the server device 502 to facilitate electronic signing of the electronic document 542.

In addition, as discussed above, the system 500 may include the connected data engine 102, as shown in FIG. 1. As discussed herein, the connected data engine 102 may implement a set of tools and/or algorithms to generate various connection interface(s) to provide connectivity and/or integration of computing systems, including, but not limited to, use of data, applications, etc. To generate such connection interface(s), the connected data engine 102, which may be part of one computing system (e.g., computing system A 302 as shown in FIG. 3) may be configured to receive one or more connection model parameters from at least another computing system (e.g., computing system B 304 as shown in FIG. 3). The engine 102 may then generate a connection data model based on the connection model parameters(s) and store the connection data model in a storage location. The engine 102 may generate such connection data model prior to receiving any requests and/or as part of a specific request received from a computing system (e.g., computing system A 302). The connection data model may be configured to generate a connection interface for connecting the two computing systems (e.g., computing system A 302 and computing system B 304).

The engine 102 may receive a connection request for connection to a computing system (e.g., computing system B 304), where the connection request may include one or more tasks to be performed using the at least one computing system. The tasks may include, for example, generation of a document by computing system A 302 using data accessed from computing system B 304, executing an application of computing system B 304 within computing environment of computing system A 302, etc. Once request is received, the connected data engine 102 may be configured to retrieve the connection data model based on the connection request. The engine 102 may retrieve the connection data model from a storage location (e.g., model registry 106 as shown in FIG. 1). Alternatively, or in addition, the engine 102 may generate the connection data model using information in the request, e.g., dynamically and/or in real-time. The connection data model may then be used to generate a connection interface for connection the computing systems (e.g., 302 and computing system B 304). Once connection interface is established, the tasks may be executed using the connection interface.

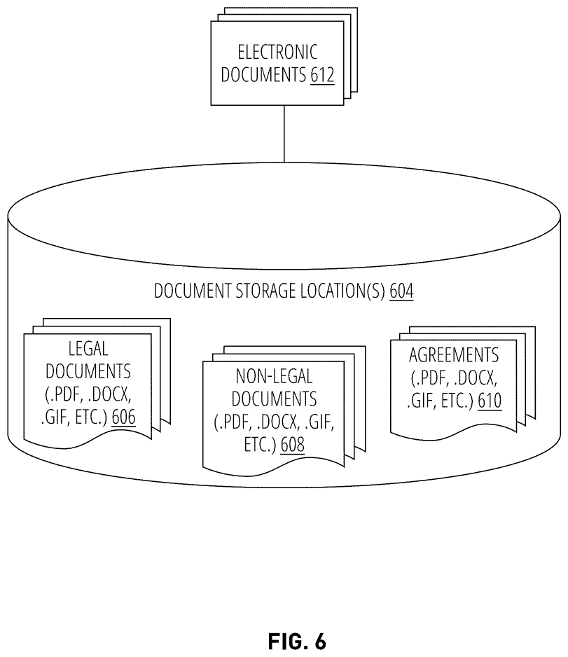

FIG. 6 illustrates an example of document storage location(s) 604 that may be used as a source for the electronic documents 612 that may be used during execution of one or more tasks, for example, according to some embodiments of the current subject matter. The document storage location(s) 604 may be a single database, repository, etc. and/or multiple databases, repositories, etc. The document storage location(s) 604 may be configured to store any type of documents, data, information, files, etc.

The documents may be any type of documents, such as, for example, agreements, applications, websites, video files, audio files, text files, images, graphics, tables, spreadsheets, computer programs, etc. For example, as shown in FIG. 6, the document storage location(s) 604 may store one or more legal documents 606, non-legal documents 608, and/or agreements 610. Any of the documents 606, 608, and/or 610 may be in any desired format, e.g., .pdf, .docx, .xls, and/or any other type of format. The documents may also have any desired size. Moreover, the documents may be organized in any desired fashion. In some examples, documents may be nested within other documents (e.g., one document embedded in another document); one document may be linked to another document, etc. As such, the document storage location(s) 604 may be a unified data storage location that may store any type, any size, any format, etc. documents, data, information, etc.

In some embodiments, the documents stored in the document storage location(s) 604 may be structured, unstructured, and/or semi-structured. Moreover, the documents may be labeled and/or unlabeled.

The documents stored in document storage location(s) 604 may be queried, searched, and/or retrieved by and/or provided to the connected data engine 102 as electronic documents 612. For example, the connected data engine 102 may retrieve all or particular sales agreements from the document storage location(s) 604 for the purposes of execution of one or more tasks using the connection interface(s) established between computing systems (e.g., computing system A 302 and computing system B 304).

FIG. 7 illustrates an example of a document corpus 708 suitable for use by the connected data engine 102 of the server device 502, such as, for example, for the purposes of execution of one or more tasks related to electronic documents (e.g., document generation, template creation, use of data and/or application of one computing system for the purposes of generation of electronic documents by another computing system, etc.). The document corpus 708 may be stored in one or more database and/or storage locations and may be accessible (e.g., via a query) by the connected data engine 102. In general, a document corpus is a large and structured collection of electronic documents, such as text documents, which are typically used for natural language processing (NLP) tasks such as text classification, sentiment analysis, topic modeling, and information retrieval. A corpus can include a variety of document types such as web pages, books, news articles, social media posts, scientific papers, and more. The corpus may be created for a specific domain or purpose, and it may be annotated with metadata or labels to facilitate analysis. Document corpora are commonly used in research and industry to train machine learning models and to develop NLP applications.

As shown in FIG. 7, the document corpus 708 may include information from electronic documents 718 derived from the document records 538 stored in the data store 526. The electronic documents 718 may include any electronic document having metadata such as STME 532 suitable for receiving an electronic signature, including both signed electronic documents or unsigned electronic documents. Different sets of the electronic documents 718 of the document corpus 708 may be associated with different entities. For example, a first set of electronic documents 718 is associated with a company A 702. A second set of electronic documents 718 is associated with a company B 704. A third set of electronic documents 718 is associated with a company C 706. A fourth set of electronic documents 718 is associated with a company D 710. Although some embodiments discuss the document corpus 708 having electronic documents 718, it may be appreciated that the document corpus 708 may have unsigned electronic document as well, which may be mined using various AI/ML techniques. Embodiments are not limited in this context.

Each set of electronic documents 718 associated with a defined entity may include one or more subsets of the electronic documents 718 categorized by document type. For instance, the second set of electronic documents 718 associated with company B 704 may have a first subset of electronic documents 718 with a document type for supply agreements 712, a second subset of electronic documents 718 with a document type for lease agreements 716, and a third subset of electronic documents 718 with a document type for service agreements 714. In one embodiment, the sets and subsets of electronic documents 718 may be identified using labels manually assigned by a human operator, such as metadata added to a document record for a signed electronic document created in a document management system, or feedback from a user of the system during a document generation process. In one embodiment, the sets and subsets of electronic documents 718 may be unlabeled.

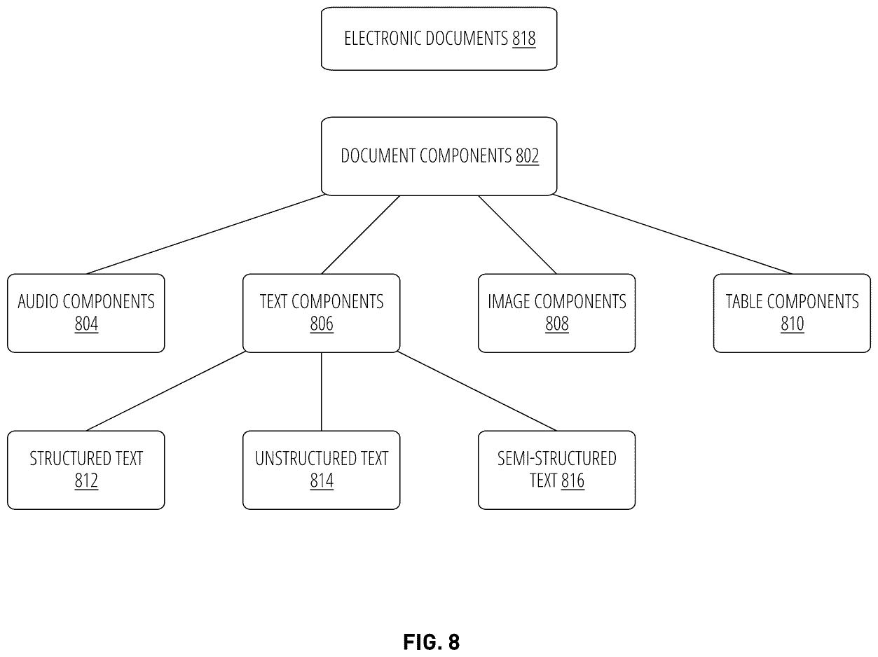

FIG. 8 illustrates an example of an electronic document 818. An electronic document 818 may include different information types that collectively form a set of document components 802 for the electronic document 818. The document components 802 may comprise, for example, one or more audio components 804, text components 806, image components 808, or table components 810. Each document component 802 may comprise different content types. For example, the text components 806 may comprise structured text 812, unstructured text 814, or semi-structured text 816.

Structured text 812 refers to text information that is organized in a specific format or schema, such as words, sentences, paragraphs, sections, clauses, and so forth. Structured text 812 has a well-defined set of rules that dictate how the data should be organized and represented, including the data types and relationships between data elements.

Unstructured text 814 refers to text information that does not have a predefined or organized format or schema. Unlike structured text 812, which is organized in a specific way, unstructured text 814 can take various forms, such as text information stored in a table, spreadsheet, figures, equations, header, footer, filename, metadata, and so forth.

Semi-structured text 816 is text information that does not fit neatly into the traditional categories of structured and unstructured data. It has some structure but does not conform to the rigid structure of a specific format or schema. Semi-structured data is characterized by the presence of context tags or metadata that provide some structure and context for the text information, such as a caption or description of a figure, name of a table, labels for equations, and so forth.

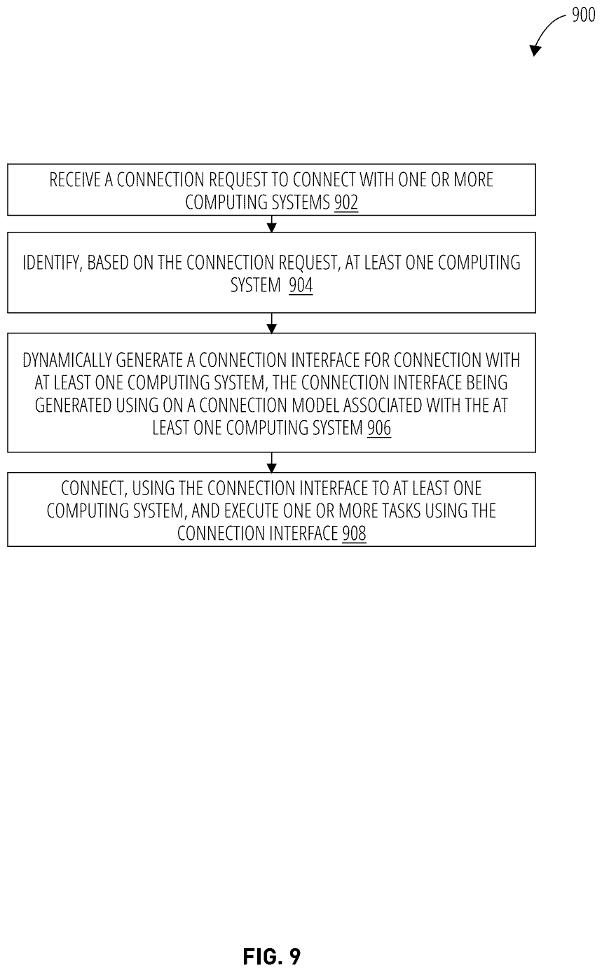

FIG. 9 illustrates an example process 900 for connecting computing systems, according to some embodiments of the current subject matter. The process 900 may be executed using one or more components of systems 100, 200, 300, as shown in FIGS. 1-3. In particular, the process 900 may be executed using connected data engine 102 shown in FIG. 1 and may be used to generate a connection interface to connect two or more computing systems (e.g., computing system A 302 and computing system B 304 as shown in FIG. 3).

At 902, the connected data engine 102 may receive a connection request (e.g., request 308 as shown in FIG. 3) to connect with one or more computing systems (e.g., computing system B 304). The request may be in connection accessing data, executing an application, etc.

At 904, the connected data engine 102 may identify, based on the connection request, at least one computing system in one or more computing systems. Such computing system may be identified based on one or more tasks associated with the connection request and to be performed using that computing system (e.g., generation, negotiation, and signing of a lease agreement).

At 906, the connected data engine 102 may dynamically generate a connection interface (e.g., connection interface 314) for connection with the identified computing system. The connection interface may be generated using on a connection data model (e.g., connection data model 312) associated with the computing system. The connection data model may be a newly generated model and/or an existing connection data model stored in a storage location. Existing connection data models may be retrieved from a storage location based on a comparison of one or more parameters associated with the received request(s), task(s), sub-task(s), etc. with one or more parameters associated with the stored connection data model(s). If a match is found (full and/or partial), specific connection data model(s) may be retrieved to generate connection interface(s). If no match is found, new connection data model(s) may be dynamically generated. The new connection data model(s) may be generated using new parameters in the request(s), task(s), sub-task(s), etc. and/or based on various combinations of parameters associated with the request(s), task(s), sub-task(s), etc. and/or parameters associated with stored connection data model(s).

At 908, the connection interface may be used to connect to the computing system and allow for execution of one or more tasks using the connection interface.

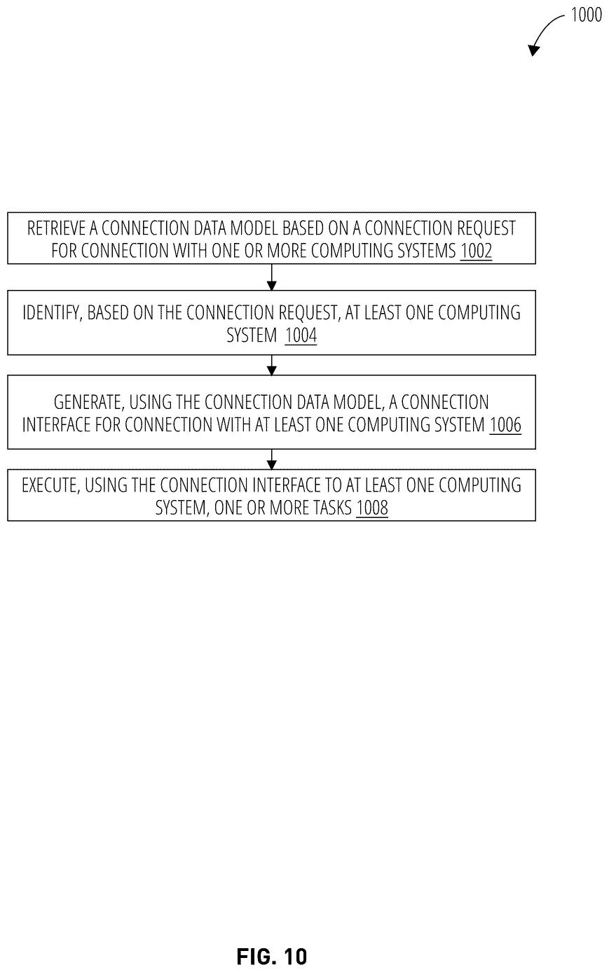

FIG. 10 illustrates another example process 1000 for connecting computing systems, according to some embodiments of the current subject matter. The process 1000 may also be executed using one or more components of systems 100, 200, 300, as shown in FIGS. 1-3. The connected data engine 102 and/or connection engine 114, shown in FIG. 1, may be used to generate a connection interface to connect two or more computing systems (e.g., computing system A 302 and computing system B 304 as shown in FIG. 3).

At 1002, the connected data engine 102 may retrieve a connection data model (e.g., connection data model 312 as shown in FIG. 3), based on a connection request (e.g., request 308) for connection with one or more computing systems. As discussed herein, existing connection data model(s) may be retrieved from a storage location based on a comparison of parameters associated with the received request(s), task(s), sub-task(s), etc. with parameters associated with the stored connection data model(s). Otherwise, a new connection data model(s) may be generated. Such model(s) may be generated using new parameters in the request(s), task(s), sub-task(s), etc. and/or based on various combinations of parameters associated with the request(s), task(s), sub-task(s), etc. and/or parameters associated with stored connection data model(s).

At 1004, the connected data engine 102 may identify, based on the connection request, at least one computing system (e.g., computing system B 304) for connection to. The computing system may be identified based on one or more tasks associated with the connection request and to be performed using the computing system.

At 1006, connection engine 114 may generate, using the connection data model, a connection interface (e.g., connection interface 314) for connection with the computing system.

At 1008, the task(s) may be executed, using the connection interface to the computing system.

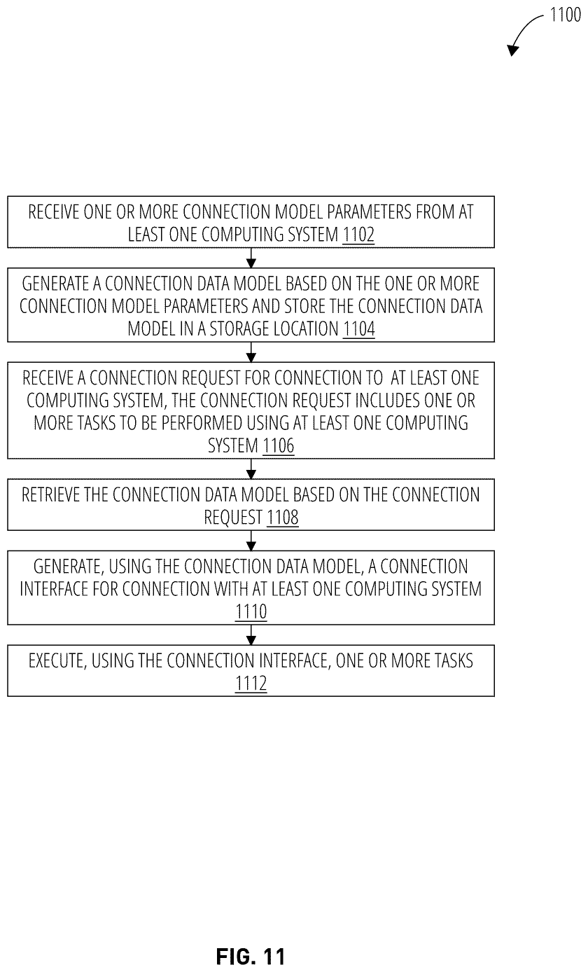

FIG. 11 illustrates yet another example process 1100 for connecting computing systems, according to some embodiments of the current subject matter. Similarly, the process 1100 may be executed using one or more components of systems 100, 200, 300, as shown in FIGS. 1-3. The connected data engine 102 and/or connection engine 114, shown in FIG. 1, may generate a connection interface for execution of the process 1000.

At 1102, the connected data engine 102 may receive one or more connection model parameters (e.g., parameter(s) 212 as shown in FIG. 2) from at least one computing system.

At 1104, the connected data engine 102 may generate a connection data model (e.g., connection data model(s) 204 as shown in FIG. 2) based on one or more connection model parameters and store the connection data model in a storage location (e.g., model registry 106).

At 1106, the connected data engine 102 may receive a connection request for connection to at least one computing system (e.g., computing system(s) 210 as shown in FIG. 2). The connection request (e.g., request 308 as shown in FIG. 3) may include one or more tasks to be performed using the computing system.

At 1108, the connected data engine 102 may retrieve the connection data model (e.g., connection data model 312) based on the connection request.

At 1110, the connected data engine 102 and/or connection engine 114 may generate, using the connection data model, a connection interface (e.g., connection interface 314) for connection with the computing system.

At 1112, the connected data engine 102 may execute, using the connection interface, one or more tasks.

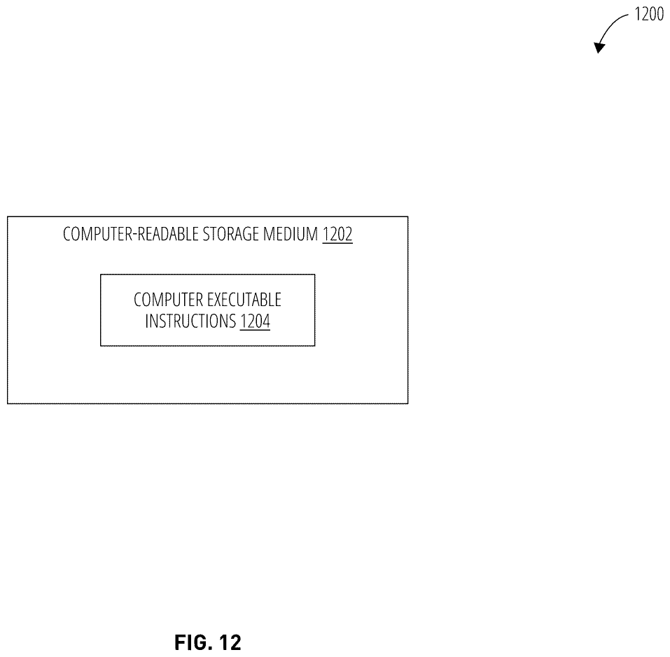

FIG. 12 illustrates an apparatus 1200. Apparatus 1200 comprises any non-transitory computer-readable storage medium 1202 or machine-readable storage medium, such as an optical, magnetic or semiconductor storage medium. In various embodiments, apparatus 1200 comprises an article of manufacture or a product. In some embodiments, the computer-readable storage medium 1202 stores computer executable instructions with which one or more processing devices or processing circuitry can execute. For example, computer executable instructions 1204 includes instructions to implement operations described with respect to any logic flows described herein. Examples of computer-readable storage medium 1202 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1204 include any suitable type of code, such as source code, compiled code, interpreted code, executable code, static code, dynamic code, object-oriented code, visual code, and the like.

FIG. 13 illustrates an embodiment of a computing architecture 1300. Computing architecture 1300 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1300 has a single processor with one core or more than one processor. Note that the term “processor” refers to a processor with a single core or a processor package with multiple processor cores. In at least one embodiment, the computing architecture 1300 is representative of the components of the system 500. More generally, the computing architecture 1300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1300. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 13, computing architecture 1300 comprises a system-on-chip (SoC) 1302 for mounting platform components. System-on-chip (SoC) 1302 is a point-to-point (P2P) interconnect platform that includes a first processor 1304 and a second processor 1306 coupled via a point-to-point interconnect 1370 such as an Ultra Path Interconnect (UPI). In other embodiments, the computing architecture 1300 is another bus architecture, such as a multi-drop bus. Furthermore, each of processor 1304 and processor 1306 are processor packages with multiple processor cores including core(s) 1308 and core(s) 1310, respectively. While the computing architecture 1300 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1304 and chipset 1332. Some platforms include additional components, and some platforms include sockets to mount the processors and/or the chipset. Furthermore, some platforms do not have sockets (e.g., SoC, or the like). Although depicted as a SoC 1302, one or more of the components of the SoC 1302 are included in a single die package, a multi-chip module (MCM), a multi-die package, a chiplet, a bridge, and/or an interposer. Therefore, embodiments are not limited to a SoC.

The processor 1304 and processor 1306 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1304 and/or processor 1306. Additionally, the processor 1304 need not be identical to processor 1306.

Processor 1304 includes an integrated memory controller (IMC) 1320 and point-to-point (P2P) interface 1324 and P2P interface 1328. Similarly, the processor 1306 includes an IMC 1322 as well as P2P interface 1326 and P2P interface 1330. IMC 1320 and IMC 1322 couple the processor 1304 and processor 1306, respectively, to respective memories (e.g., memory 1316 and memory 1318). Memory 1316 and memory 1318 are portions of the main memory (e.g., a dynamic random-access memory (DRAM)) for the platform such as double data rate type 4 (DDR 4) or type 5(DDR 5 ) synchronous DRAM (SDRAM). In the present embodiment, the memory 1316 and the memory 1318 locally attach to the respective processors (i.e., processor 1304 and processor 1306). In other embodiments, the main memory couple with the processors via a bus and shared memory hub. Processor 1304 includes registers 1312 and processor 1306 includes registers 1314.

Computing architecture 1300 includes chipset 1332 coupled to processor 1304 and processor 1306. Furthermore, chipset 1332 are coupled to storage device 1350, for example, via an interface (I/F) 1338. The I/F 1338 may be, for example, a Peripheral Component Interconnect-enhanced (PCIe) interface, a Compute Express Link® (CXL) interface, or a Universal Chiplet Interconnect Express (UCIe) interface. Storage device 1350 stores instructions executable by circuitry of computing architecture 1300 (e.g., processor 1304, processor 1306, GPU 1348, accelerator 1354, vision processing unit 1356, or the like).

Processor 1304 couples to the chipset 1332 via P2P interface 1328 and P2P 1334 while processor 1306 couples to the chipset 1332 via P2P interface 1330 and P2P 1336. Direct media interface (DMI) 1376 and DMI 1378 couple the P2P interface 1328 and the P2P 1334 and the P2P interface 1330 and P2P 1336, respectively. DMI 1376 and DMI 1378 is a high-speed interconnect that facilitates, e.g., eight Giga Transfers per second (GT/s) such as DMI 3.0. In other embodiments, the processor 1304 and processor 1306 interconnect via a bus.

The chipset 1332 comprises a controller hub such as a platform controller hub (PCH). The chipset 1332 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1332 comprises more than one controller hub such as a chipset with a memory controller hub, a graphics controller hub, and an input/output (I/O) controller hub.

In the depicted example, chipset 1332 couples with a trusted platform module (TPM) 1344 and UEFI, BIOS, FLASH circuitry 1346 via I/F 1342. The TPM 1344 is a dedicated microcontroller designed to secure hardware by integrating cryptographic keys into devices. The UEFI, BIOS, FLASH circuitry 1346 may provide pre-boot code. The I/F 1342 may also be coupled to a network interface circuit (NIC) 1380 for connections off-chip.

Furthermore, chipset 1332 includes the I/F 1338 to couple chipset 1332 with a high-performance graphics engine, such as, graphics processing circuitry or a graphics processing unit (GPU) 1348. In other embodiments, the computing architecture 1300 includes a flexible display interface (FDI) (not shown) between the processor 1304 and/or the processor 1306 and the chipset 1332. The FDI interconnects a graphics processor core in one or more of processor 1304 and/or processor 1306 with the chipset 1332.

The computing architecture 1300 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1354 and/or vision processing unit 1356 are coupled to chipset 1332 via I/F 1338. The accelerator 1354 is representative of any type of accelerator device (e.g., a data streaming accelerator, cryptographic accelerator, cryptographic co-processor, an offload engine, etc.). One example of an accelerator 1354 is the Intel® Data Streaming Accelerator (DSA). The accelerator 1354 is a device including circuitry to accelerate copy operations, data encryption, hash value computation, data comparison operations (including comparison of data in memory 1316 and/or memory 1318), and/or data compression. Examples for the accelerator 1354 include a USB device, PCI device, PCIe device, CXL device, UCIe device, and/or an SPI device. The accelerator 1354 also includes circuitry arranged to execute machine learning (ML) related operations (e.g., training, inference, etc.) for ML models. Generally, the accelerator 1354 is specially designed to perform computationally intensive operations, such as hash value computations, comparison operations, cryptographic operations, and/or compression operations, in a manner that is more efficient than when performed by the processor 1304 or processor 1306. Because the load of the computing architecture 1300 includes hash value computations, comparison operations, cryptographic operations, and/or compression operations, the accelerator 1354 greatly increases performance of the computing architecture 1300 for these operations.

The accelerator 1354 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1354. For example, the accelerator 1354 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1354 via a non-posted write (e.g., a deferred memory write (DMWr)). One example of an instruction that atomically submits a work descriptor to the shared work queue of the accelerator 1354 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1354. The dedicated work queue may accept job submissions via commands such as the movdir64b instruction.

Various I/O devices 1360 and display 1352 couple to the bus 1372, along with a bus bridge 1358 which couples the bus 1372 to a second bus 1374 and an I/F 1340 that connects the bus 1372 with the chipset 1332. In one embodiment, the second bus 1374 is a low pin count (LPC) bus. Various input/output (I/O) devices couple to the second bus 1374 including, for example, a keyboard 1362, a mouse 1364 and communication devices 1366.

Furthermore, an audio I/O 1368 couples to second bus 1374. Many of the I/O devices 1360 and communication devices 1366 reside on the system-on-chip (SoC) 1302 while the keyboard 1362 and the mouse 1364 are add-on peripherals. In other embodiments, some or all the I/O devices 1360 and communication devices 1366 are add-on peripherals and do not reside on the system-on-chip (SoC) 1302.

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400.

As shown in FIG. 14, the communications architecture 1400 includes one or more clients 1402 and servers 1404. The clients 1402 and the servers 1404 are operatively connected to one or more respective client data stores 1408 and server data stores 1410 that can be employed to store information local to the respective clients 1402 and servers 1404, such as cookies and/or associated contextual information.

The clients 1402 and the servers 1404 communicate information between each other using a communication framework 1406. The communication framework 1406 implements any well-known communications techniques and protocols. The communication framework 1406 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1406 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/100/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1402 and the servers 1404. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application, or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct, or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose, or it comprises a general-purpose computer as selectively activated or reconfigured by a computer program stored in the computer. The procedures presented herein are not inherently related to a particular computer or other apparatus. Various general-purpose machines are used with programs written in accordance with the teachings herein, or it proves convenient to construct more specialized apparatus to perform the required method steps. The required structure for a variety of these machines are apparent from the description given.

The following examples pertain to further embodiments, from which numerous permutations and configurations will be apparent.

In one aspect, a computer-implemented method includes receiving, using at least one processor, a connection request to connect with one or more computing systems; identifying, using the at least one processor, based on the connection request, at least one computing system in the one or more computing systems, the at least one computing system is identified based on one or more tasks associated with the connection request and to be performed using the at least one computing system; dynamically generating, using the at least one processor, a connection interface for connection with the at least one computing system, the connection interface being generated using on a connection data model associated with the at least one computing system; and connecting, using the at least one processor, using the connection interface to the at least one computing system, and executing the one or more tasks using the connection interface.

The method may also include wherein the one or more tasks is associated with an electronic document.

The method may also include wherein the one or more tasks includes at least one of: generating the electronic document, modifying the electronic document, storing the electronic document, or any combination thereof using data stored by the at least one computing system.

The method may also include wherein the one or more tasks are configured to be performed by at least one of: the at least one computing system, the at least one processor, or any combination thereof.

The method may also include wherein the dynamically generating includes receiving, using the at least one processor, one or more connection model parameters from the at least one computing system; generating, using the at least one processor, the connection data model based on the one or more connection model parameters; and storing, using the at least one processor, the connection data model in a storage location.

The method may also include wherein the one or more connection model parameters are historical connection model parameters received from the at least one computing system and associated with one or more historical connection interfaces with the at least one computing system generated for executing one or more historical tasks.

The method may also include wherein the one or more connection model parameters are received from the at least one computing system in real-time.

The method may also include wherein the dynamically generating includes retrieving, using the connection request, the connection data model from the storage location; and generating, using the retrieved connection data model, the connection interface in real-time.

The method may also include wherein the connection interface is an application programming interface.

In one aspect, a system may include at least one processor; and at least one non-transitory storage media storing instructions, that when executed by the at least one processor, cause the at least one processor to: retrieve a connection data model based on a connection request for connection with one or more computing systems; identify, based on the connection request, at least one computing system in one or more computing systems, the at least one computing system is identified based on one or more tasks associated with the connection request and to be performed using the at least one computing system; generate, using the connection data model, a connection interface for connection with the at least one computing system; and execute, using the connection interface to the at least one computing system, the one or more tasks.

The system may include wherein the one or more tasks is associated with an electronic document.

The system may include wherein the one or more tasks includes at least one of: generating the electronic document, modifying the electronic document, storing the electronic document, or any combination thereof using data stored by the at least one computing system.

The system may include wherein the one or more tasks are configured to be performed by at least one of: the at least one computing system, the at least one processor, or any combination thereof.

The system may include wherein generation of the connection interface includes receiving one or more connection model parameters from the at least one computing system; generating the connection data model based on the one or more connection model parameters; and storing, using the at least one processor, the connection data model in a storage location.

The system may include wherein the one or more connection model parameters are historical connection model parameters received from the at least one computing system and associated with one or more historical connection interfaces with the at least one computing system generated for executing one or more historical tasks.

The system may include wherein the one or more connection model parameters are received from the at least one computing system in real-time.

The system may include wherein generation of the connection interface includes retrieving, using the connection request, the connection data model from the storage location; and generating, using the retrieved connection data model, the connection interface in real-time.

The system may include wherein the connection interface is an application programming interface.

In aspect, a non-transitory computer-readable storage medium, the computer-readable storage medium including instructions that when executed by at least one processor, cause the at least one processor to: receive one or more connection model parameters from at least one computing system; generate a connection data model based on the one or more connection model parameters and store the connection data model in a storage location; receive a connection request for connection to the at least one computing system, the connection request includes one or more tasks to be performed using the at least one computing system; retrieve the connection data model based on the connection request; generate, using the connection data model, a connection interface for connection with the at least one computing system; and execute, using the connection interface, the one or more tasks.

The non-transitory computer-readable storage medium may include wherein the connection interface is an application programming interface.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

1. A computer-implemented method, comprising:
receiving, using at least one processor, a connection request to connect with one or more computing systems;
identifying, using the at least one processor, based on the connection request, at least one computing system in the one or more computing systems, the at least one computing system is identified based on one or more tasks associated with the connection request and to be performed using the at least one computing system;
dynamically generating, using the at least one processor, a connection interface for connection with the at least one computing system, the connection interface being generated using a connection data model associated with the at least one computing system; and
connecting, using the at least one processor, using the connection interface to the at least one computing system, and executing the one or more tasks using the connection interface within the at least one computing system.

2. The method of claim 1, wherein the one or more tasks is associated with an electronic document.

3. The method of claim 2, wherein the one or more tasks includes at least one of: generating the electronic document, modifying the electronic document, storing the electronic document, or any combination thereof using data stored by the at least one computing system.

4. The method of claim 2, wherein the one or more tasks are configured to be performed by at least one of: the at least one computing system, the at least one processor, or any combination thereof.

5. The method of claim 1, wherein the dynamically generating includes
receiving, using the at least one processor, one or more connection model parameters from the at least one computing system;
generating, using the at least one processor, the connection data model based on the one or more connection model parameters; and
storing, using the at least one processor, the connection data model in a storage location.

6. The method of claim 5, wherein the one or more connection model parameters are historical connection model parameters received from the at least one computing system and associated with one or more historical connection interfaces with the at least one computing system generated for executing one or more historical tasks.

7. The method of claim 5, wherein the one or more connection model parameters are received from the at least one computing system in real-time.

8. The method of claim 5, wherein the dynamically generating includes
retrieving, using the connection request, the connection data model from the storage location; and
generating, using the retrieved connection data model, the connection interface in real-time.

9. The method of claim 1, wherein the connection interface is an application programming interface.

10. A system, comprising:
at least one processor; and
at least one non-transitory storage media storing instructions, that when executed by the at least one processor, cause the at least one processor to:
retrieve a connection data model based on a connection request for connection with one or more computing systems;
identify, based on the connection request, at least one computing system in one or more computing systems, the at least one computing system is identified based on one or more tasks associated with the connection request and to be performed using the at least one computing system;
generate, using the connection data model, a connection interface for connection with the at least one computing system; and
execute, using the connection interface to the at least one computing system, the one or more tasks within the at least one computing system.

11. The system of claim 10, wherein the one or more tasks is associated with an electronic document.

12. The system of claim 11, wherein the one or more tasks includes at least one of: generating the electronic document, modifying the electronic document, storing the electronic document, or any combination thereof using data stored by the at least one computing system.

13. The system of claim 11, wherein the one or more tasks are configured to be performed by at least one of: the at least one computing system, the at least one processor, or any combination thereof.

14. The system of claim 10, wherein generation of the connection interface includes
receiving one or more connection model parameters from the at least one computing system;
generating the connection data model based on the one or more connection model parameters; and
storing, using the at least one processor, the connection data model in a storage location.

15. The system of claim 14, wherein the one or more connection model parameters are historical connection model parameters received from the at least one computing system and associated with one or more historical connection interfaces with the at least one computing system generated for executing one or more historical tasks.

16. The system of claim 14, wherein the one or more connection model parameters are received from the at least one computing system in real-time.

17. The system of claim 14, wherein generation of the connection interface includes
retrieving, using the connection request, the connection data model from the storage location; and
generating, using the retrieved connection data model, the connection interface in real-time.

18. The system of claim 10, wherein the connection interface is an application programming interface.

19. A non-transitory computer-readable storage medium, the computer-readable storage medium including instructions that when executed by at least one processor, cause the at least one processor to:
receive one or more connection model parameters from at least one computing system;
generate a connection data model based on the one or more connection model parameters and store the connection data model in a storage location;
receive a connection request for connection to the at least one computing system, the connection request includes one or more tasks to be performed using the at least one computing system;
retrieve the connection data model based on the connection request;
generate, using the connection data model, a connection interface for connection with the at least one computing system; and
execute, using the connection interface, the one or more tasks within the at least one computing system.

20. The non-transitory computer-readable storage medium of claim 19, wherein the connection interface is an application programming interface.
